(19) United States
(12) Patent Application Publication
(10) Pub. No.: US 2025/0132787 A1
(43) Pub. Date: Apr. 24, 2025

(54) SENSING PROCESSING METHOD AND APPARATUS, TERMINAL, AND DEVICE

(71) Applicant: VIVO MOBILE COMMUNICATION CO., LTD., Dongguan (CN)

(72) Inventors: Shengli DING, Dongguan (CN); Dajie JIANG, Dongguan (CN); Jian YAO, Dongguan (CN)

(73) Assignee: VIVO MOBILE COMMUNICATION CO., LTD., Dongguan (CN)

(21) Appl. No.: 19/006,171

(22) Filed: Dec. 30, 2024

Related U.S. Application Data
(63) Continuation of application No. PCT/CN2023/106308, filed on Jul. 7, 2023.

(30) Foreign Application Priority Data
Jul. 14, 2022 (CN) 202210834751.8

(51) Int. Cl. H04B 7/04

(52) U.S. Cl. CPC H04B 7/04013

(57) ABSTRACT

This application provides a sensing processing method and apparatus, a terminal, and a device. The method includes: obtaining, by a first device, a first sensing result and a second sensing result; and determining, by the first device, a first parameter based on the first sensing result and the second sensing result. The first sensing result is a measurement sensing result obtained through sensing measurement on a reference target based on a first signal, and the second sensing result is a reference sensing result corresponding to the reference target. The first parameter is used to indicate a measurement error of the sensing measurement. The reference target includes at least one of the following: a moving target within a preset range; a specified target area; or a device equipped with intelligent reflection surface or backscatter communication.

### CROSS-REFERENCE TO RELATED APPLICATIONS

This application is a continuation of International Application No. PCT/CN 2023/106308, filed on Jul. 7, 2023, which claims priority to Chinese Patent Application No. 202210834751.8, filed on Jul. 14, 2022. The entire contents of each of the above-referenced applications are expressly incorporated herein by reference.

### TECHNICAL FIELD

This application pertains to the field of integrated sensing and communication technologies, and specifically, to a sensing processing method and apparatus, a terminal, and a device.

### BACKGROUND

With development of communication technologies, a future wireless communication system is expected to provide high-precision sensing services. The sensing and communication systems are usually designed separately and occupy different frequency bands. Due to wide deployment of millimeter wave and massive Multiple-Input Multiple-Output (MIMO) technologies, communication signals in the future wireless communication system often have high resolution in time domain and angle domain, which makes it possible to implement high-precision sensing by using communication signals. Therefore, the joint design of sensing and communication systems enables to share same frequency bands and hardware, thereby improving frequency efficiency and reducing hardware costs, and pushing research on Integrated Sensing And Communication (ISAC).

However, when multiple devices are involved in transmission and reception of sensing signals or integrated sensing and communication signals in the process of sensing measurement, some errors exist in sensing measurement, which leads to the problem of relatively low accuracy of sensing measurement.

### SUMMARY

Embodiments of this application provide a sensing processing method and apparatus, a terminal, and a device.

According to a first aspect, a sensing processing method is provided, including:
obtaining, by a first device, a first sensing result and a second sensing result, where the first sensing result is a measurement sensing result obtained through sensing measurement on a reference target based on a first signal, and the second sensing result is a reference sensing result corresponding to the reference target; and
determining, by the first device, a first parameter based on the first sensing result and the second sensing result, where the first parameter is used to indicate a measurement error of the sensing measurement; where
the reference target includes at least one of the following:
a moving target within a preset range;
a specified target area; and
a device equipped with intelligent reflection surface or backscatter communication.

According to a second aspect, a sensing processing apparatus is provided, including:
a first obtaining module, configured to obtain a first sensing result and a second sensing result, where the first sensing result is a measurement sensing result obtained through sensing measurement on a reference target based on a first signal, and the second sensing result is a reference sensing result corresponding to the reference target; and
a first processing module, configured to determine a first parameter based on the first sensing result and the second sensing result, where the first parameter is used to indicate a measurement error of the sensing measurement; where
the reference target includes at least one of the following:
a moving target within a preset range;
a specified target area; and
a device equipped with intelligent reflection surface or backscatter communication.

According to a third aspect, a sensing processing method is provided, including:
performing, by a sensing node, sensing measurement on a reference target based on a first signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to a fourth aspect, a sensing processing apparatus is provided, including:
a second processing module, configured to perform sensing measurement on a reference target based on a first signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to a fifth aspect, a sensing processing method is provided, including:
performing, by a sensing node, sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to a sixth aspect, a sensing processing apparatus is provided, including:
a third processing module, configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to a seventh aspect, a terminal is provided, where the terminal includes a processor and a memory, and a program or instructions capable of running on the processor are stored in the memory. When the program or the instructions are executed by the processor, the steps of the method according to the third aspect or the fifth aspect are implemented.

According to an eighth aspect, a terminal is provided, including a processor and a communication interface, where
the processor is configured to perform sensing measurement on a reference target based on a first signal; or
the processor is configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to a ninth aspect, a network-side device is provided, where the network-side device includes a processor and a memory, and a program or instructions capable of running on the processor are stored in the memory. When the program or the instructions are executed by the processor, the steps of the method according to the first aspect, the third aspect, or the fifth aspect are implemented.

According to a tenth aspect, a network-side device is provided, including a processor and a communication interface, where
in a case that the network-side device is a first device, the processor is configured to obtain a first sensing result and a second sensing result, where the first sensing result is a measurement sensing result obtained through sensing measurement on a reference target based on a first signal, and the second sensing result is a reference sensing result corresponding to the reference target; and determine a first parameter based on the first sensing result and the second sensing result, where the first parameter is used to indicate a measurement error of the sensing measurement; or
in a case that the network-side device is a sensing node, the processor is configured to perform sensing measurement on a reference target based on a first signal; or the processor is configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

According to an eleventh aspect, a sensing processing system is provided, including: a terminal and a network-side device, where the terminal may be configured to perform the steps of the sensing processing method according to the third aspect or the fifth aspect, and the network-side device may be configured to perform the steps of the sensing processing method according to the first aspect or the third aspect or the fifth aspect.

According to a twelfth aspect, a server is provided, where the server includes a processor and a communication interface, the communication interface is coupled to the processor, and the processor is configured to run a program or instructions to implement the steps of the method according to the first aspect.

According to a thirteenth aspect, a readable storage medium is provided, where a program or instructions are stored in the readable storage medium; and when the program or the instructions are executed by a processor, the steps of the method according to the first aspect are implemented, or the steps of the method according to the third aspect are implemented, or the steps of the method according to the fifth aspect are implemented.

According to a fourteenth aspect, a chip is provided, where the chip includes a processor and a communication interface, the communication interface is coupled to the processor, and the processor is configured to run a program or instructions to implement the method according to the first aspect, or implement the method according to the third aspect, or implement the method according to the fifth aspect.

According to a fifteenth aspect, a computer program/program product is provided, where the computer program/program product is stored in a storage medium, and the computer program/program product is executed by at least one processor to implement the steps of the method according to the first aspect, the steps of the method according to the third aspect, or the steps of the method according to the fifth aspect.

In the embodiments of this application, the measurement sensing result is obtained through sensing measurement on the reference target based on the first signal, and the first parameter can be determined based on the measurement sensing result and the reference sensing result of the reference target to obtain the measurement error of the sensing measurement, which can facilitate subsequent compensation for the sensing measurement based on the measurement error and improve accuracy of the sensing measurement.

### BRIEF DESCRIPTION OF DRAWINGS

FIG. 1 is a block diagram of a wireless communication system according to an embodiment of this application;

FIG. 2 is a first flowchart of a sensing processing method according to an embodiment of this application;

FIG. 3 is a first schematic diagram of two-dimensional spectrum of “delay-Doppler”;

FIG. 4 is a second schematic diagram of two-dimensional spectrum of “delay-Doppler”;

FIG. 5 is a third schematic diagram of two-dimensional spectrum of “delay-Doppler”;

FIG. 6 is a first schematic diagram of a method application scenario according to an embodiment of this application;

FIG. 7 is a second schematic diagram of a method application scenario according to an embodiment of this application;

FIG. 8 is a third schematic diagram of a method application scenario according to an embodiment of this application;

FIG. 9 is a fourth schematic diagram of a method application scenario according to an embodiment of this application;

FIG. 10 is a second flowchart of a sensing processing method according to an embodiment of this application;

FIG. 11 is a third flowchart of a sensing processing method according to an embodiment of this application;

FIG. 12 is a first structural diagram of a sensing processing apparatus according to an embodiment of this application;

FIG. 13 is a second structural diagram of a sensing processing apparatus according to an embodiment of this application;

FIG. 14 is a third structural diagram of a sensing processing apparatus according to an embodiment of this application;

FIG. 15 is a structural diagram of a communication device according to an embodiment of this application;

FIG. 16 is a structural diagram of a terminal according to an embodiment of this application;

FIG. 17 is a structural diagram of a network-side device according to an embodiment of this application; and

FIG. 18 is a structural diagram of another network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate a specific order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that techniques described in the embodiments of this application are not limited to a Long Term Evolution (LTE) or LTE-Advance, (LTE-A) system, and may also be applied to various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

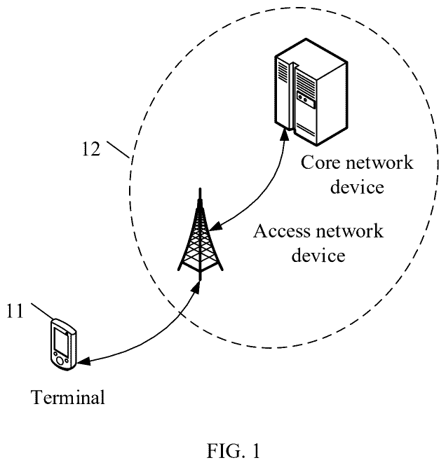

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a Wearable Device (WD), Vehicle User Equipment (VUE), Pedestrian User Equipment (PUE), a smart home device (a home device with wireless communication function, such as a refrigerator, a television, a washing machine, or a furniture), a game console, a Personal Computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the terminal 11 is not limited in the embodiments of this application. The network-side device 12 may include an access network device or a core network device, where the access network device may also be referred to as a radio access network device, a Radio Access Network (RAN), a radio access network function, or a radio access network unit. The access network device may include a base station, a Wireless Local Area Network (WLAN) access point, a wireless fidelity Wi-Fi node, or the like. The base station may be referred to as a nodeB, an evolved nodeB (CNB), an access point, a Base Transceiver Station (BTS), a radio base station, a radio transceiver, a Basic Service Set (BSS), an Extended Service Set (ESS), a home nodeB, a home evolved nodeB, a transmission and reception point (Transmitting Receiving Point (TRP)), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, a core network device in an NR system is used as an example for description, and a specific type of the core network device is not limited.

For ease of understanding, the following describes some content included in the embodiments of this application.

### 1. Integrated Sensing and Communication

In the future, B5G and 6G wireless communication systems are expected to provide various high-precision sensing services, such as indoor positioning of robot navigation, Wi-Fi sensing of smart homes, and radar sensing of self-driving vehicles. The sensing and communication systems are usually designed separately and occupy different frequency bands. Due to wide deployment of millimeter wave and massive MIMO technologies, communication signals in the future wireless communication system often have high resolution in time domain and angle domain, which makes it possible to implement high-precision sensing by using communication signals. Therefore, the best way is to jointly design the sensing and communication systems to share same frequency bands and hardware, thereby improving frequency efficiency and reducing hardware costs. This prompts the study of ISAC. ISAC will become a key technology in the future wireless communication systems to support many important application scenarios. For example, in the future self-driving vehicle network, self-driving vehicles may obtain a lot of information from the network, including ultra-high resolution maps and near-real-time information, so as to perform navigation and avoid upcoming traffic congestion. Under the same circumstances, radar sensors in self-driving vehicles should be able to provide powerful and high-resolution obstacle detection function, with a resolution in the order of centimeters. The ISAC technology for the self-driving vehicles provides the possibility of high data rate communication and high resolution obstacle detection using the same hardware and spectrum resources. Other applications of ISAC include indoor positioning and activity recognition based on Wi-Fi, communication and sensing of unmanned aerial vehicles, Extended Reality (XR), integration of radar and communication, and the like.

ISAC allows low-cost integration of communication and sensing functions by sharing hardware devices and defining functions by software. Its main features are: (1) unified and simplified architecture; (2) reconfigurable and extensible functions; and (3) improved efficiency and reduced costs. The advantages of integrated sensing and communication mainly include three aspects: (1) smaller device costs and reduced size; (2) improved spectrum utilization rate; and (3) improved system performance.

The development of ISAC is divided into four stages: coexistence, co-operation, co-design, and collaboration.

Coexistence: Communication and sensing are two separate systems, which interfere with each other. The main method for mitigating the interference is: distance isolation, frequency band isolation, time division working, Multiple Input Multiple Output (MIMO) technology, precoding, and the like.

Co-operation: Communication and sensing share a same hardware platform, and use common information to improve common performance. Power distribution between them imposes relatively great impact on the system performance.

Co-design: Communication and sensing become a complete joint system, including joint signal design, waveform design, coding design, and the like. In the early stage, there were linear frequency modulation waveforms and spread spectrum waveforms, and later the focus moves onto Orthogonal Frequency Division Multiplexing (OFDM) waveforms, MIMO technology, and the like.

Collaboration: Multiple communication-sensing integrated nodes cooperate with each other to implement common purposes. For example, radar detection information is shared through communication data transmission. Typical scenarios include a driver assistance system, radar-assisted communication, and the like.

### 2. Radar Technology

With the development of the radar technology, radar-based target detection allows not only measurement on a distance of a target, but also measurement on a speed, azimuth angle, and pitch angle of the target, and also allows extracting of more information about the target from the foregoing information, including a size and shape of the target.

The radar technology was originally used for military purposes to detect targets such as airplanes, missiles, vehicles, and ships. With the development of technologies and the evolution of society, radar is increasingly used in civil scenarios. The typical application is that meteorological radar measures echo of meteorological targets such as clouds and rain to determine the location and intensity of clouds and rain for weather forecast. Further, with vigorous development of the electronic information industry, Internet of things, and communication technologies, the radar technology has been applied to people's daily lives, greatly improving convenience and safety of work and life. For example, automotive radar provides early warning information for vehicle driving by measuring a distance and a relative speed between vehicles, between vehicles and surrounding objects, and between vehicles and pedestrians, which greatly improves the safety level of road traffic.

On the technical level, radar classification is in many manners. Based on a position relationship between radar transceiver stations, it can be classified into monostatic radar and bistatic radar. For monostatic radar, the signal transmitter and receiver are integrated and share an antenna. The advantages lie in that the target echo signal is naturally coherent with a local oscillator of the receiver, and signal processing is relatively convenient. The disadvantages lie in that the signal cannot be transmitted and received simultaneously, and only signal waveforms with a specific duty cycle can be used, which causes blind spots of detection and needs to be compensated by using complex algorithms; or transmission and reception of signals are performed simultaneously, with strict isolation between transmission and reception, which is very difficult for the high-power military radar. For bistatic radar, the signal transmitter and receiver are located in different locations. The advantages lie in that the signal can be transmitted and received simultaneously, and the continuous wave waveforms can be used for detection. The disadvantages lie in that co-frequency and coherence between the receiver and the transmitter are difficult to implement, and signal processing is relatively complex.

In wireless sensing applications of integrated sensing and communication, the radar technology can adopt monostatic radar mode or bistatic radar mode.

In the monostatic radar mode, transmission and reception of signals share a same antenna, and a received signal and a transmitted signal enter different radio frequency processing links through a circulator. In this mode, continuous wave signal waveforms can be used to implement detection without blind spots, provided that the received signal and the transmitted signal need to be well isolated, usually requiring isolation of about 100 dB, so as to eliminate inundation of the received signal caused by leakage of the transmitted signal. Because the receiver of the monostatic radar has all information of the transmitted signal, the signal can be processed through matched filtering (pulse compression) to obtain higher signal processing gain.

In bistatic radar mode, there is no problem of signal isolation, which greatly simplifies the complexity of hardware. Because radar signal processing is based on known information, in the integrated sensing and communication applications of 5G NR, known information such as a synchronization signal and a reference signal can be used for radar signal processing. However, due to periodicity of a synchronization signal and reference signal, an ambiguity diagram of signal waveforms is no longer a pushpin shape, but a pinboard shape, and the ambiguity degree of delay and Doppler will increase, and the gain of main lobes may be much lower than that in the monostatic radar mode, which will reduce the measurement range of distance and speed. Through proper design of parameter sets, the measurement range of distance and speed can meet measurement requirements of common targets such as cars and pedestrians. In addition, the measurement accuracy of bistatic radar is related to the positions of the transceiver stations relative to the target, so it is necessary to choose an appropriate transceiver station pair to improve the detection performance.

The following describes in detail a sensing processing method provided in the embodiments of this application by using some embodiments and application scenarios thereof with reference to the accompanying drawings.

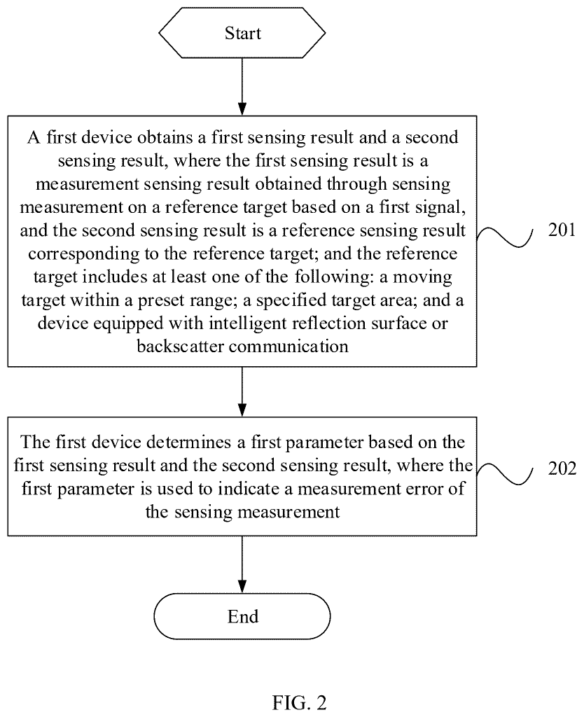

As shown in FIG. 2, an embodiment of this application provides a sensing processing method, including the following steps.

Step 201: A first device obtains a first sensing result and a second sensing result, where the first sensing result is a measurement sensing result obtained through sensing measurement on a reference target based on a first signal, and the second sensing result is a reference sensing result corresponding to the reference target.

The reference target includes at least one of the following:
a moving target within a preset range;
a specified target area; and
a device equipped with intelligent reflection surface or backscatter communication.

Here, the reference target is a target whose reference sensing result is known. The first signal is sent by a transmit end device of sensing measurement, reflected by the reference target, and received by a receive end device of the sensing measurement. The second sensing result is a more accurate sensing result corresponding to the reference target than the first sensing result, and the second sensing result may be a sensing result obtained by any method other than the first signal. Therefore, in this step, the first device obtains the first sensing result and the second sensing result corresponding to the reference target, so as to perform the next step.

Step 202: The first device determines a first parameter based on the first sensing result and the second sensing result, where the first parameter is used to indicate a measurement error of the sensing measurement.

In this step, based on the first sensing result and the second sensing result obtained in step 201, the first device determines the first parameter that can indicate the measurement error of the sensing measurement, so that a transmit end and a receive end of the subsequent sensing measurement can perform more accurate sensing measurement on a sensing object without known sensing result based on the first parameter, thereby improving accuracy of the sensing measurement.

In this way, the first device performs steps 201 and 202 of obtaining the first sensing result through sensing measurement on the reference target based on the first signal and determining the first parameter based on the first sensing result and the second sensing result of the reference target to obtain the measurement error of the sensing measurement, which can facilitate subsequent compensation for the sensing measurement based on the measurement error and improve accuracy of the sensing measurement.

For example, in this embodiment, the first device may be a sensing function network element; or, when at least one of the transmit end and the receive end of the first signal is a base station, the first device may be a base station; or, the first device may be a server. The sensing function network element is a network function node responsible for at least one function such as sensing request processing, sensing resource scheduling, sensing information interaction, sensing data processing in a core network and/or Radio Access Network (RAN), and may be a base station, or an upgraded AMF or LMF based on related 5G networks, or other network function nodes or newly defined network function nodes.

For example, in this embodiment, the first sensing result includes at least one of the following: delay, Doppler, and angle.

The second sensing result includes at least one of the following: delay, Doppler, and angle.

For example, in some embodiments, before step 201, the method further includes:
obtaining, by the first device, first information of a target sensing node, where the target sensing node includes at least one of a first sensing node and a second sensing node; and
determining whether to estimate a measurement error of the sensing measurement based on the first information of the target sensing node.

That is, after obtaining first information of the first sensing node and/or the second sensing node, the first device can further determine based on the first information whether to estimate the measurement error of the sensing measurement, that is, whether to perform the foregoing steps 201 and 202.

For example, the first information includes at least one of the following:
information related to a frequency source of the target sensing node, such as whether frequency sources of the first sensing node and the second sensing node are a same frequency source;
information related to a clock of the target sensing node, such as whether clocks of the first sensing node and the second sensing node are a same clock;
a method related to frequency source synchronization of the target sensing node, such as whether the first sensing node or the second sensing node has software and hardware capabilities for frequency source synchronization;
a method related to clock synchronization of the target sensing node, such as whether the first sensing node or the second sensing node has software and hardware capabilities for clock synchronization;
information related to a deviation of the frequency source of the target sensing node, such as stability of the frequency sources between the first sensing node and the second sensing node and a range of frequency deviation obtained therefrom;
information related to a deviation of the clock of the target sensing node, such as stability of the clock between the first sensing node and the second sensing node and a range of clock deviation obtained therefrom; and
information related to a phase deviation between antennas of the sensing node corresponding to the receive end of the first signal in the sensing measurement process, such as an index of the phase deviation between the antennas or a calibration status of the phase deviation between the antennas.

For example, one of the first sensing node and the second sensing node is a transmit end device of the first signal, and the other of the first sensing node and the second sensing node is a receive end device of the first signal. Both the first sensing node and the second sensing node may be one or more devices.

For example, the obtaining, by the first device, first information of a target sensing node includes any one of the following:
sending, by the first device, first signaling to the target sensing node and receiving the first information from the target sensing node based on the first signaling; and
obtaining, by the first device, the first information from a first network-side device.

That is, the first device may send the first signaling to the first sensing node and/or the second sensing node, and the first sensing node and/or the second sensing node that receives the first signaling returns the first information to the first device. In addition, in some embodiments, the first device may access a first network-side device to obtain the first information, where the first information of the first sensing node and/or the second sensing node is stored in the first network-side device.

For example, the first signaling satisfies at least one of the following:
the first signaling is signaling sent in a process of selecting a sensing node, or the first signaling is signaling sent after the target sensing node is determined; and
the first signaling is signaling dedicated to querying the first information.

For example, in some embodiments, the method further includes:
obtaining, by the first device, second information in a case that it is determined to estimate the measurement error of the sensing measurement; where
the second information includes at least one of the following:
location information of the target sensing node;
capability information of the target sensing node;
sensing a-priori information;
location information of a candidate sensing node in a preset spatial range;
capability information of the candidate sensing node in the preset spatial range;
sensing subscription information of the candidate sensing node in the preset spatial range;
sensing permission information of the candidate sensing node in the preset spatial range; and
third information of the reference target.

In this embodiment, the second information is used for selecting one from a plurality of candidate sensing nodes by the first device to act as a third sensing node. The third sensing node is one or more sensing nodes used for cooperatively determining the first parameter.

For example, the preset spatial range is determined based on at least one of location information of the target sensing node, capability information of the target sensing node, and sensing a-priori information.

For example, the sensing subscription information of the candidate sensing node includes whether the candidate sensing node agrees to act as the third sensing node, a time range for agreeing to act as the third sensing node, and the like.

For example, the sensing permission information of the candidate sensing node includes: whether (a regulatory department or the network) permits the candidate sensing node to perform sensing, a time range of being permitted to perform sensing, and the like.

For example, in some embodiments, the obtaining, by the first device, second information includes:
in a case that the second information includes the location information of the target sensing node and/or the candidate sensing node, performing, by the first device, the following operation:
if the target sensing node and/or the candidate sensing node is a device with a fixed location, obtaining location information by accessing a first network function or receiving a report from the target sensing node and/or the candidate sensing node; where the first network function stores device location information; or
if the target sensing node and/or the candidate sensing node is a mobile device, obtaining location information by accessing a second network function; where the second network function is a positioning related network function.

That is, a manner of obtaining the location information of the target sensing node and/or the candidate sensing node may be as follows: in a case that the target sensing node and/or the candidate sensing node is a device with a fixed location (such as a base station and TRP), the first device obtains the location information of the target sensing node and/or the candidate sensing node by accessing a first network function storing device location information; or receives the location information through reporting of the target sensing node and/or the candidate sensing node.

In addition, in some embodiments, a manner of obtaining the location information of the target sensing node and/or the candidate sensing node may be as follows: in a case that the target sensing node and/or the candidate sensing node is a mobile device (such as UE), the first device obtains the location information of the target sensing node and/or the candidate sensing node by accessing a network function related to positioning, that is, a second network function. Here, the second network function may be a positioning management function, such as a Location Management Function (LMF) and a network function for receiving Minimization of Drive Test (MDT) location information. In some embodiments, the second network function may be a positioning service function, such as an Application Function (AF), where the AF may be a positioning server such as wireless local area network (Wi-Fi), Bluetooth, Zigbee or Ultra Wide Band (UWB), or may be an application function (such as a map Application (APP)) capable of obtaining positioning information such as Global Positioning System (GPS).

For example, in some embodiments, the obtaining, by the first device, second information includes:
in a case that the second information includes target information and the target information is at least one of the capability information of the target sensing node and/or the candidate sensing node, the sensing subscription information, and the sensing permission information, performing, by the first device, any one of the following operations:
sending, by the first device, second signaling to the target sensing node and/or the candidate sensing node, and receiving the target information from the target sensing node and/or the candidate sensing node based on the second signaling; and
obtaining, by the first device, the target information from a second network-side device, where the second network-side device stores the target information.

That is, a manner of obtaining the capability information of the target sensing node and/or the candidate sensing node, and the sensing subscription information and the sensing permission information of the candidate sensing node may be as follows: the first device sends the second signaling to the target sensing node and/or the candidate reference target, and the target sensing node and/or the candidate sensing node that receives the second signaling returns its capability information to the first device. In addition, in some embodiments, a manner of obtaining the capability information of the target sensing node and/or the candidate sensing node, and the sensing subscription information and the sensing permission information of the candidate sensing node may be as follows: obtaining by the first device by accessing a second network-side device, where the second network-side device stores the target information.

For example, in some embodiments, the obtaining, by the first device, second information includes:

in a case that the second information includes the sensing a-priori information and/or third information of the reference target, obtaining, by the first device, the sensing a-priori information and/or the third information of the reference target from an initiating node of a sensing service or a network node related to the initiating node.

For example, the sensing a-priori information includes at least one of the following:
spatial range information of a sensing target area;
a-priori information of a spatial location of a sensing object; and
motion parameter a-priori information of the sensing object.

For example, the third information of the reference target includes at least one of the following:
spatial position range information of the reference target;
spatial range information of a reference target area;
motion parameter information of the reference target; and
modulation information of the reference target.

For example, the motion parameter information of the reference target includes a motion speed range and an acceleration range of the reference target.

For example, the modulation information of the reference target is modulation information of the reference target equipped with intelligent reflection surface or Backscatter Communication (BSC), including a modulation sequence, a modulation format, and a modulation rate. The modulation sequence may include: sequence type and sequence length. The modulation format may include: modulation signal dimension (such as amplitude, phase, polarization, or frequency) and quantization bit number. In some embodiments, the intelligent reflection surface may be referred to as Reconfigurable Intelligent Surface (RIS).

In some embodiments, the reference target of RIS or BSC modulates its own Identity (ID) sequence onto the signal based on a specific modulation format and rate.

For example, in some embodiments, after the obtaining, by the first device, second information, the method further includes:
determining, by the first device, a third sensing node based on the second information;
sending, by the first device, third signaling to the third sensing node, where the third signaling is used to indicate that a device receiving the third signaling is selected as the third sensing node; and
receiving, by the first device, fourth signaling returned by the third sensing node, where the fourth signaling is used to indicate whether a device sending the fourth signaling agrees to act as the third sensing node.

For example, any one of the third sensing nodes may have the following requirements:
1. Capable of performing sensing services in a spontaneous transmission and reception manner; where, in this case, the any one sensing node includes one device.
2. Capable of performing sensing services in a manner of transmitting by A and receiving by B; where in this case, the any one sensing node includes a transmit end device A and a receive end device B in the manner of transmitting by A and receiving by B; moreover, in this case, at least one of a timing error, a frequency offset, and an antenna phase deviation between the transmit end device A and the receive end device B has been calibrated, including but not limited to: frequency sources and/or clocks of the transmit end device A and the receive end device B are a same frequency source and/or clock, or frequency sources and/or clocks prepared by the transmit end device A and the receive end device B have been synchronized in a manner of GPS-based second pulse, or a phase deviation between antennas of the receive end device B has been calibrated by various means.

For example, the third sensing node may include a first sensing node and/or a second sensing node.

For example, if the transmit end device and the receive end device of the third sensing node are not a same device, the third signaling may be used to indicate that the device receiving the third signaling is a transmit end device or the receive end device in the third sensing node. Correspondingly, the returned fourth signaling may further be used to indicate whether the device sending the fourth signaling agrees to act as the transmit end device or the receive end device in the third sensing node.

For example, in this embodiment, in a case that the fourth signaling indicates that the device sending the fourth signaling agrees to act as the third sensing node, or the transmit end device in the third sensing node, or the receive end device in the third sensing node, subsequent processing is then performed; otherwise, the step of determining the third sensing node is performed again. If no device agrees to act as the third sensing node, or the transmit end device in the third sensing node, or the receive end device in the third sensing node, the first device may report such event to the network and end the procedure.

For example, in some embodiments, before the obtaining, by a first device, a first sensing result and a second sensing result, the method further includes:
determining, by the first device, a first configuration of a first signal and a second configuration of a second signal; where
the second signal is used for performing sensing measurement on the reference target by the third sensing node.

For example, the second signal is a sensing signal that is sent and received by the third sensing node and that is used for sensing the reference target. For example, the first configuration and the second configuration may be the same or different.

For example, the first configuration is determined based on fourth information, and the fourth information includes at least one of the following:
location information of the target sensing node;
capability information of the target sensing node;
sensing a-priori information; and
third information of the reference target.

For example, the second configuration is determined based on fifth information, and the fifth information includes at least one of the following:
location information of the third sensing node;
capability information of the third sensing node;
sensing a-priori information; and
third information of the reference target.

For example, the first configuration or the second configuration includes at least one of the following: signal waveform, signal format, frequency domain configuration, time domain configuration, spatial domain configuration, energy domain configuration, and signal transceiving mode.

For example, the signal waveform may include OFDM, Orthogonal Time Frequency Space (OTFS), Frequency Modulated Continuous Wave (FMCW), Single-carrier Frequency-Division Multiple Access (SC-FDMA), and the like.

For example, the signal format may include Demodulation Reference Signal (DMRS), Positioning Reference Signal (PRS), Channel State Information Reference Signal (CSI-RS), and the like.

For example, the frequency domain configuration may include a bandwidth, a subcarrier spacing, a starting frequency, a starting position of a Resource Block (RB) or Resource element (RE), an offset of RB or RE, a frequency domain spacing between adjacent REs or RBs, and a bitmap of RE or RB.

For example, the time domain configuration may include a sensing signal period, a sensing frame period, a sensing update period, a starting position of an OFDM symbol or slot, an OFDM symbol or slot offset, a time interval between adjacent OFDM symbols or slots, a bitmap of OFDM symbols or slots, a time of performing estimation on a timing error and/or frequency offset and/or phase deviation between antennas for the first time, a time interval between two estimations performed on the timing error and/or frequency offset and/or phase deviation between antennas, and the like.

For example, the spatial domain configuration may include beam direction, antenna parameter configuration, Quasi co-location (QCL) relationship between beams, and the like. The antenna parameter configuration further includes: antenna panel configuration (including the number and coordinates of antenna panels), antenna element configuration (including the number and coordinates of antenna elements), MIMO configuration (including an orthogonal mode (Time division Multiplexing (TDM), Frequency Division Multiplexing (FDM), Doppler Division Multiplexing (DDM), Code Division Multiplexing (CDM), or the like) of multiple signals and corresponding parameters).

For example, the energy domain configuration can include: peak power, average power, and the like.

For example, the signal transceiving mode includes at least one of the following:
spontaneous transmission and reception of signals by a sensing node;
transmission and reception of unidirectional signals between two sensing nodes; and
transmission and reception of bidirectional signals between two sensing nodes.

Spontaneous transmission and reception performed by the sensing node may be a transmission and reception manner used when the third sensing node includes only one device.

The transmission and reception of unidirectional signal may be unidirectional signal transmission and reception between two devices. For example, the first sensing node sends a first signal and the second sensing node receives the first signal; or, the first sensing node receives the first signal and the second sensing node sends the first signal; or, one device in the third sensing node sends the second signal and the other device receives the second signal.

The transmission and reception of bidirectional signals may be transmission and reception of the bidirectional signals between two devices. Such transmission and reception manner may be used between the first sensing node and the second sensing node, or may be used when the third sensing node includes multiple devices. For example, the first sensing node sends a first signal and the second sensing node receives the first signal sent by the first sensing node, and the second sensing node sends a first signal and the first sensing node receives the first signal sent by the second sensing node; or, a device C in the third sensing node sends a second signal and another device D receives the second signal sent by the device C, and the device D sends a second signal and the device C receives the second signal sent by the device D.

For example, after the determining, by the first device, a second configuration of a second signal, the following is further included:
sending, by the first device, the second configuration to the third sensing node.

In this way, the third sensing node can implement the sensing measurement on the reference target based on the second signal.

For example, after the determining, by the first device, a first configuration of a first signal, the following is further included:
sending, by the first device, the first configuration to the first sensing node and/or the second sensing node.

In this way, the first sensing node and the second sensing node can implement the sensing measurement on the reference target based on the first signal.

For example, in some embodiments, after the determining, by the first device, a first configuration of a first signal, the method further includes:
performing, by the first device, sensing measurement on the reference target based on the first signal according to the first configuration to obtain a third sensing result.

For example, the performing, by the first device, sensing measurement on the reference target based on the first signal according to the first configuration to obtain a third sensing result includes:
in a case that the first device is a receive end of the first signal in the target sensing node, receiving, by the first device, the first signal to obtain first data, and determining, by the first device, the third sensing result based on the first data;
in a case that the first device is a transmit end of the first signal in the target sensing node, sending, by the first device, the first signal, and receiving, from a sensing node corresponding to the receive end of the first signal or a sensing function network element, a corresponding third sensing result obtained based on the sensing measurement; and in a case that the first device is the sensing function network element, receiving, by the first device, second data from a sensing node corresponding to the receive end of the first signal, and determining the third sensing result based on the second data.

The first data is data obtained through operations on the received first signal such as down-converting, filtering, sampling, and extracting.

For example, in a case that the first device is a receive end of the first signal in the target sensing node, the determining, by the first device, the third sensing result based on the first data includes any one of the following:
performing, by the first device, a first operation on the first data to obtain the third sensing result; and
sending, by the first device, third data to a sensing function network element, and receiving, from the sensing function network element, a third sensing result determined based on the third data, where the third data includes the first data or a first intermediate sensing result obtained by performing a second operation based on the first data, and the third sensing result is determined by the sensing function network element by performing a first operation on the first data or performing a third operation based on the first intermediate sensing result, the second operation is part of the first operation, and the third operation is an operation other than the second operation in the first operation.

For example, in some embodiments, in a case that the first device is a sensing function network element, the determining, by the first device, the third sensing result based on the second data includes any one of the following:
in a case that the second data includes first data corresponding to the sensing measurement, performing, by the first device, a first operation on the first data to obtain the third sensing result;
in a case that the second data includes a first intermediate sensing result obtained by performing a second operation based on the first data, performing, by the first device, a third operation on the first intermediate sensing result to obtain the third sensing result; where the second operation is part of the first operation, and the third operation is an operation other than the second operation in the first operation; and
in a case that the second data includes the third sensing result, obtaining, by the first device, the third sensing result through receiving.

It should be noted that in a case that the first device does not participate in calculation of the sensing result, the first device can merely receive the third sensing result from other devices. For example, in some embodiments, the first device receives the third sensing result from a sensing node corresponding to the receive end of the first signal or a sensing function network element in the sensing measurement process.

It should be further noted that in some embodiments, if the first device is a device that calculates the first sensing result, the first device can further send the third sensing result to other devices that require the sensing result, for example, sending the third sensing result to a device such as the sensing function network element or a sensing requesting party.

For example, the transmit end of the first signal in the sensing measurement process may generate and send a first signal based on the first configuration; the receive end of the first signal receives the first signal in the sensing measurement process to obtain first data; and the receive end of the first signal and/or the sensing function network element performs signal processing and/or data processing in the sensing measurement process.

The signal processing and/or data processing includes the following cases:
Case 1: The receive end of the first signal performs a first operation on the first data in the sensing measurement process to obtain a third sensing result.

For example, the receive end of the first signal in the sensing measurement process sends the third sensing result to the first device.
Case 2: The receive end of the first signal performs a second operation on the first data in the sensing measurement process to obtain a first intermediate sensing result, and sends the first intermediate sensing result to the sensing function network element; and the sensing function network element performs a third operation on the first intermediate sensing result to obtain the third sensing result. The second operation is part of the first operation, and the third operation is an operation other than the second operation in the first operation.

For example, the sensing function network element sends the third sensing result to the first device.
Case 3: The receive end of the first signal sends the first data to the sensing function network element in the sensing measurement process, and the sensing function network element performs the first operation on the first data to obtain the third sensing result.

For example, the sensing function network element sends the third sensing result to the first device.

For example, in some embodiments, after the sending, by the first device, the second configuration to the third sensing node, the following is further included:
performing, by the first device, sensing measurement on the reference target based on the second signal according to the second configuration to obtain a fourth sensing result.

For example, the performing, by the first device, sensing measurement on the reference target based on the second signal according to the second configuration to obtain a fourth sensing result includes:
in a case that the first device is the first sensing node or the second sensing node, receiving, by the first device, a fourth sensing result corresponding to the sensing measurement from a sensing function network element; and
in a case that the first device is a sensing function network element, receiving, by the first device, fourth data from a sensing node corresponding to the receive end of the second signal, and determining the fourth sensing result based on the fourth data.

For example, in some embodiments, in a case that the first device is a sensing function network element, the determining, by the first device, the fourth sensing result based on the fourth data includes any one of the following:
when the fourth data includes fifth data corresponding to the sensing measurement, performing, by the first device, a fourth operation on the fifth data to obtain the third sensing result; and
when the fourth data includes a second intermediate sensing result obtained by performing a fifth operation on the fifth data, performing, by the first device, a sixth operation on the second intermediate sensing result to obtain a fourth sensing result; where the fifth operation is part of the fourth operation, and the sixth operation is an operation other than the fifth operation in the fourth operation.

The fifth data is data obtained through operations on the received second signal such as down-converting, filtering, sampling, and extracting.

It should be noted that when the first device does not participate in calculation of the sensing result, the first device can merely receive the fourth sensing result from other devices. For example, in some embodiments, the first device receives the fourth sensing result from a sensing node corresponding to the receive end of the second signal or a sensing function network element in the sensing measurement process.

It should be further noted that in some embodiments, if the first device is a device that calculates the fourth sensing result, the first device can further send the fourth sensing result to other devices that require the sensing result, for example, sending the fourth sensing result to a device such as a sensing function network element or a sensing requesting party.

For example, the transmit end of the second signal in the sensing measurement process may generate and send a second signal based on the second configuration; the receive end of the second signal receives the second signal in the sensing measurement process to obtain fifth data; and the receive end of the second signal and/or the sensing function network element performs signal processing and/or data processing in the sensing measurement process.

The signal processing and/or data processing includes the following cases:
Case 1: The receive end of the second signal performs a fourth operation on the fifth data in the sensing measurement process to obtain a fourth sensing result.

For example, the receive end of the second signal in the sensing measurement process sends the fourth sensing result to the first device.
Case 2: The receive end of the second signal performs a fifth operation on the fifth data in the sensing measurement process to obtain a second intermediate sensing result, and sends the second intermediate sensing result to the sensing function network element; and the sensing function network element performs a sixth operation on the second intermediate sensing result to obtain the fourth sensing result. The fifth operation is part of the fourth operation, and the sixth operation is an operation other than the fifth operation in the fourth operation.

For example, the sensing function network element sends the fourth sensing result to the first device.
Case 3: The receive end of the second signal sends the fifth data to the sensing function network element in the sensing measurement process, and the sensing function network element performs the fourth operation on the fifth data to obtain the fourth sensing result.

For example, the sensing function network element sends the fourth sensing result to the first device.

For example, the third sensing result or the fourth sensing result includes at least one of: distance; Doppler; angle; one-dimensional spectrum of range; one-dimensional spectrum of Doppler; one-dimensional spectrum of angle; two-dimensional spectrum of distance and Doppler; two-dimensional spectrum of azimuth angle and pitch angle; two-dimensional spectrum of distance and angle; three-dimensional spectrum of distance, azimuth angle, and pitch angle; three-dimensional spectrum of distance, Doppler, and angle; and four-dimensional spectrum of range, Doppler, azimuth angle, and pitch angle.

It should be noted that the foregoing obtained third sensing result may include a plurality, and the plurality may be averaged, or a third sensing result corresponding to the first data with the largest power or the largest Signal to Noise ratio (SNR) may be used as a final third sensing result for subsequent processing. Similarly, the obtained fourth sensing result includes a plurality, and the final fourth sensing result may be obtained in the foregoing manner, for subsequent processing.

For example, in some embodiments, the obtaining, by a first device, a first sensing result and a second sensing result includes:
determining, by the first device, the first sensing result and/or the second sensing result based on the third sensing result and/or the fourth sensing result.

For example, the determining, by the first device, the first sensing result and/or the second sensing result based on the third sensing result and/or the fourth sensing result includes:
determining, by the first device, the first sensing result based on the third sensing result, and determining the second sensing result based on the fourth sensing result; or
determining, by the first device, the first sensing result and the second sensing result based on the third sensing result and the fourth sensing result.

For example, in some embodiments, the determining, by the first device, the first sensing result and the second sensing result based on the third sensing result and the fourth sensing result includes at least one of the following:
separately determining, by the first device, the first sensing result and the second sensing result based on patterns with associated characteristics in the third sensing result and the fourth sensing result;
performing, by the first device, matching on the third sensing result and the fourth sensing result, and separately determining the first sensing result and the second sensing result based on successfully matched patterns in the third sensing result and the fourth sensing result; and
extracting, by the first device, the first sensing result and the second sensing result from the third sensing result and the fourth sensing result based on modulation information of the reference target.

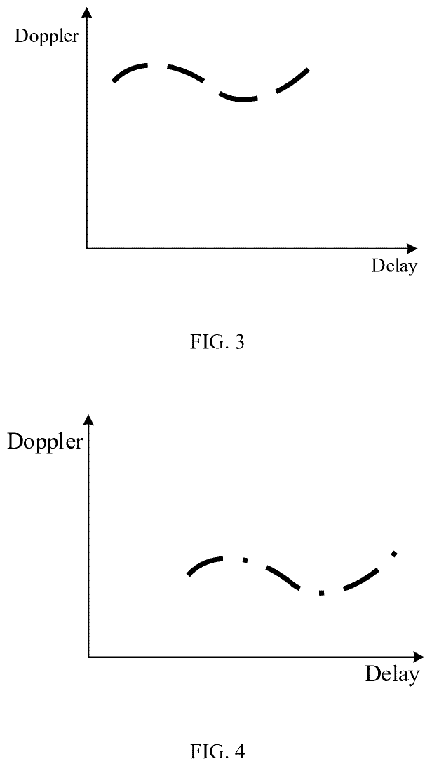

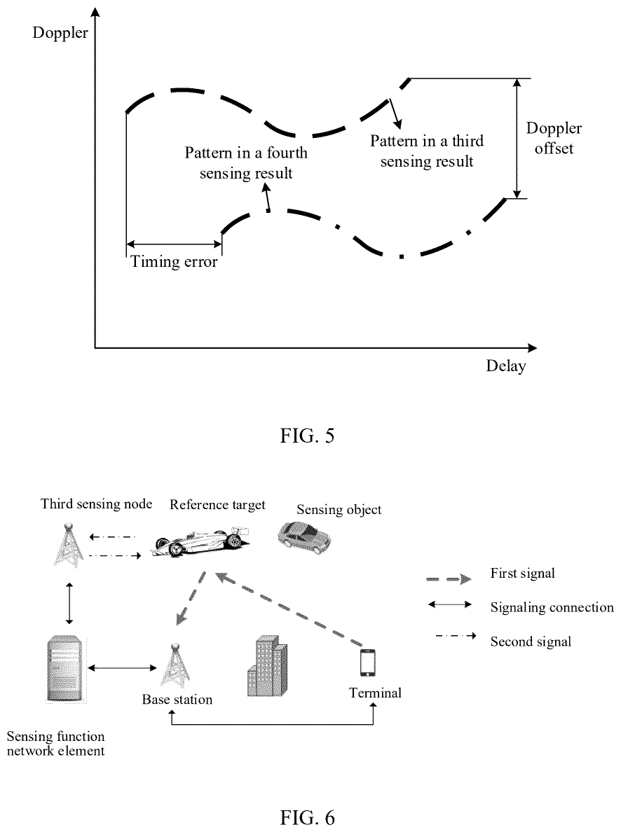

In some embodiments, a manner of determining the first sensing result and the second sensing result by the first device may be as follows:
Manner 1: Beams of the first sensing node or the second sensing node, and the third sensing node are aimed at a same spatial range (for example, a specific road section) for simultaneous (or almost simultaneous) sensing, and a unit with the largest Doppler in the obtained third sensing result (two-dimensional spectrum of delay-Doppler) and a unit with the largest Doppler in the obtained fourth sensing result (two-dimensional spectrum of delay-Doppler) are considered as sensing results of a same reference target (for example, a car driving on the road), the delays and Dopplers corresponding to the unit with the largest Doppler in the third sensing result and the unit with the largest Doppler in the fourth sensing result are the first sensing result and the second sensing result respectively.
Manner 2: Beams of the first sensing node or the second sensing node, and the third sensing node are aimed at a same spatial range (for example, a specific road section) for simultaneous (or almost simultaneous) sensing, to respectively obtain the third sensing result (as shown in FIG. 3) and the fourth sensing result (as shown in FIG. 4), which are both two-dimensional spectrum of delay-Doppler. The two-dimensional spectrum of “delay-Doppler” shown in FIG. 5 is radar patterns in the third sensing result and the fourth sensing result successfully matched, so as to identify a path or cluster corresponding to the reference target in the first signal based on the matching result to obtain the first sensing result of the reference target, and identify a path or cluster corresponding to the reference target in the second signal based on the matching result to obtain the second sensing result of the reference target.
Manner 3: Beams of the first sensing node or the second sensing node, and the third sensing node are aimed at a same spatial range (for example, a specific building) for simultaneous (or almost simultaneous) sensing, to obtain the third sensing result (two-dimensional spectrum of delay-azimuth) and the fourth sensing result (two-dimensional spectrum of delay-azimuth). Image matching is performed on the first sensing result and the second sensing result to extract radar imaging corresponding to the building separately from the third sensing result and the fourth sensing result, so as to obtain delay and angle information corresponding to the building in the third sensing result and the fourth sensing result, which are the first sensing result and the second sensing result respectively.

For example, in some embodiments, the first parameter includes at least one of the following:
a timing error between the first sensing node and the second sensing node;
a frequency offset between the first sensing node and the second sensing node; and
a phase deviation between antennas of a sensing node corresponding to a receive end of the first signal; where
the first sensing node and the second sensing node are used for performing sensing measurement on a reference target based on the first signal.

It should be noted that a corresponding manner for determining the first parameter is different in different transceiving modes.

For example, in some embodiments, in a case that a signal transceiving mode of the first signal is transmission and reception of unidirectional signals between the first sensing node and the second sensing node, the determining, by the first device, a first parameter based on the first sensing result and the second sensing result includes at least one of the following:
determining a timing error in the first parameter based on a delay in the first sensing result and a delay in the second sensing result;
determining a frequency offset in the first parameter based on a Doppler in the first sensing result and a Doppler in the second sensing result; and
determining a phase deviation between antennas of a fourth sensing node in the first parameter based on a first measured phase between the antennas of the fourth sensing node and a first reference phase between the antennas of the fourth sensing node, where the first measurement phase is determined through derivation based on an angle in the first sensing result, the first reference phase is determined through derivation based on an angle in the second sensing result, the fourth sensing node is the first sensing node or the second sensing node, and the fourth sensing node is a sensing node corresponding to the receive end of the first signal.

For example, in some embodiments, a result obtained by subtracting the delay in the second sensing result from the delay in the first sensing result may be determined as a timing error; a result obtained by subtracting the Doppler in the second sensing result from the Doppler in the first sensing result may be determined as a frequency offset; and a result obtained by subtracting the first reference phase from the first measured phase may be determined as a phase deviation between the antennas of the fourth sensing node.

For example, in some embodiments, in a case that the signal transceiving mode of the first signal is transmission and reception of bidirectional signals between the first sensing node and the second sensing node, the determining, by the first device, a first parameter based on the first sensing result and the second sensing result includes at least one of the following:
determining a timing error in the first parameter based on a first delay, a second delay, and a delay in the second sensing result; where the first delay is a delay in the first sensing result that is obtained based on the second sensing node acting as a receive end of the first signal, and the second delay is a delay in the first sensing result that is obtained based on the second sensing node acting as a transmit end of the first signal;
determining a frequency offset in the first parameter based on a first Doppler, a second Doppler, and a Doppler in the second sensing result; where the first Doppler is a Doppler in the first sensing result that is obtained based on the second sensing node acting as a receive end of the first signal, and the second Doppler is a Doppler in the first sensing result that is obtained based on the second sensing node acting as a transmit end of the first signal; and
determining a phase deviation between antennas of a fourth sensing node in the first parameter based on a first measured phase between the antennas of the fourth sensing node and a first reference phase between the antennas of the fourth sensing node, where the first measurement phase is determined through derivation based on an angle in the first sensing result, the first reference phase is determined based on an angle in the second sensing result, the fourth sensing node is the first sensing node or the second sensing node, and the fourth sensing node is a sensing node corresponding to a receive end of the first signal.

For example, in some embodiments, a result obtained by subtracting the delay in the second sensing result from the first delay in the first sensing result may be determined as a first timing error, and a result obtained by subtracting the delay in the second sensing result from the second delay in the first sensing result may be determined as a second timing error. In this case, the timing error in the first parameter may be an average value of the first timing error and the second timing error.

For example, in some embodiments, a result obtained by subtracting the Doppler in the second sensing result from the first Doppler in the first sensing result may be determined as a first frequency offset, and a result obtained by subtracting the Doppler in the second sensing result from the second Doppler in the first sensing result may be determined as a second frequency offset. In this case, the frequency offset in the first parameter may be an average value of the first frequency offset and the second frequency offset.

For example, in some embodiments, a result obtained by subtracting the first reference phase from the first measured phase may be determined as the phase deviation between the antennas of the fourth sensing node.

For example, after the first sensing result and the second sensing result are determined in the foregoing manner 1 or manner 3, coordinate system transformation is performed based on information such as location information (the location information of the first sensing node or the second sensing node, and the third sensing node) and a beam direction (a beam direction of the first signal and the second signal), and the second sensing result is transformed into a same coordinate system as the first sensing result to obtain a fifth sensing result. In this case, it is considered that accuracy of the fifth sensing result is relatively high (because the timing error and/or frequency offset of the second sensing node has been calibrated), so deviations of the delay and Doppler in the first sensing result and the fifth sensing result are respectively errors of the delay and Doppler in the first sensing result, and phase deviations between the antennas of the receive end device of the first signal derived from the angles in the first sensing result and the fifth sensing result respectively are phase deviations between the antennas of the receive end device of the first signal.

For another example, after the first sensing result and the second sensing result are determined in the foregoing manner 2, at least one of the timing error between the transmit end device and the receive end device of the first signal, the frequency offset, and the phase deviation between the antennas of the receive end device of the first signal can be obtained based on the first sensing result and the second sensing result.

For example, in some embodiments, after the determining, by the first device, a first parameter based on the first sensing result and the second sensing result, the method further includes:
determining, by the first device, a target parameter based on the first parameter, where the target parameter is used for compensating a measurement error of the sensing node; and
sending, by the first device, at least part of the target parameters to a target device, where the target device includes at least one of a first sensing node, a second sensing node, and a sensing function network element.

In a case that the first device and the first sensing node are not a same device, the first device sends at least part of the target parameters to the first sensing node;

in a case that the first device and the second sensing node are not a same device, the first device sends at least part of the target parameters to the second sensing node; and

in a case that the first device and the sensing function network element are not a same device, the first device sends at least part of the target parameters to the sensing function network element.

It should be further noted that, in some embodiments, values of multiple sets of first parameters can be obtained by performing the foregoing sensing measurement for many times, and finally a measurement error ultimately used for compensating the sensing node is determined based on the values of the multiple sets of first parameters, that is, the measurement error for compensating the first sensing node and the second sensing node during sensing measurement is determined. Therefore, the target parameter is determined based on N groups of first parameters determined by the first device, where N is a positive integer.

In a case that N is equal to 1, the target parameter is the first parameter; and in a case that N is greater than 1, the target parameter satisfies any one of the following:
each parameter value in the target parameter is an average value of corresponding parameter values in the N groups of first parameters;
the target parameter is a group of first parameters with the highest received signal quality in the N groups of first parameters; and
each parameter value in the target parameter is an average value of corresponding parameter values in L groups of first parameters, where the L groups of first parameters are L groups of first parameters ranking the front in descending order of corresponding received signal quality in the N groups of first parameters, and L is an integer greater than 1.

The received signal quality may include a received signal power, a Reference Signal Received Power (RSRP), a Reference Signal Received Quality (RSRQ), an RSSI, an SNR of the received signal, and the like.

For example, in some embodiments, in a case that the first configuration or the second configuration includes a time domain configuration, the following is performed repeatedly: performing corresponding sensing measurement, determining the first sensing result and the second sensing result, determining the first parameter, determining the target parameter, and transmitting at least part of the target parameters.

The following describes specific application of the method in the embodiments of this application in combination with specific scenarios.
Scenario 1: For uplink sensing shown in FIG. 6, the terminal sends a first signal and the base station receives the first signal, and generation of the sensing result is completed by the sensing function network element. This embodiment aims to perform sensing on a sensing object in the figure. In this embodiment, the first device is a sensing function network element, the transmit end of the first signal (such as the first sensing node) is a terminal, the receive end of the first signal (such as the second sensing node) is a base station, the third sensing node is a device with a spontaneous transmission and reception capability, and the reference target is a moving vehicle.

To compensate for a timing error and frequency offset between the terminal and the base station, or a phase deviation between antenna ports of the base station so as to more accurately obtain a delay, Doppler, or angle of the sensing object for measurement, sensing is performed on the reference target by the third sensing node (using the spontaneous transmission and reception of the base station as an example) under scheduling of the sensing function network element to obtain a sensing result of the reference target as the fourth sensing result corresponding to the reference target. In addition, for the uplink sensing between the terminal and the base station, sensing is also performed on the reference target to obtain a third sensing result with at least one of the timing error, the frequency offset, and the phase deviation between antenna ports.

Based on the third sensing result and the fourth sensing result, the first sensing result and the second sensing result are obtained. In this embodiment, the reference target is a moving vehicle, which has obvious characteristics in the two-dimensional spectrum of delay-Doppler, and the first sensing result and the second sensing result are obtained through matching on the two-dimensional spectrum of delay-Doppler of the third sensing result and the fourth sensing result.

Based on the first sensing result and the second sensing result, the sensing function network element obtains at least one of the timing error between the terminal and the base station, the frequency offset, and the phase deviation between the antenna ports of the base station.

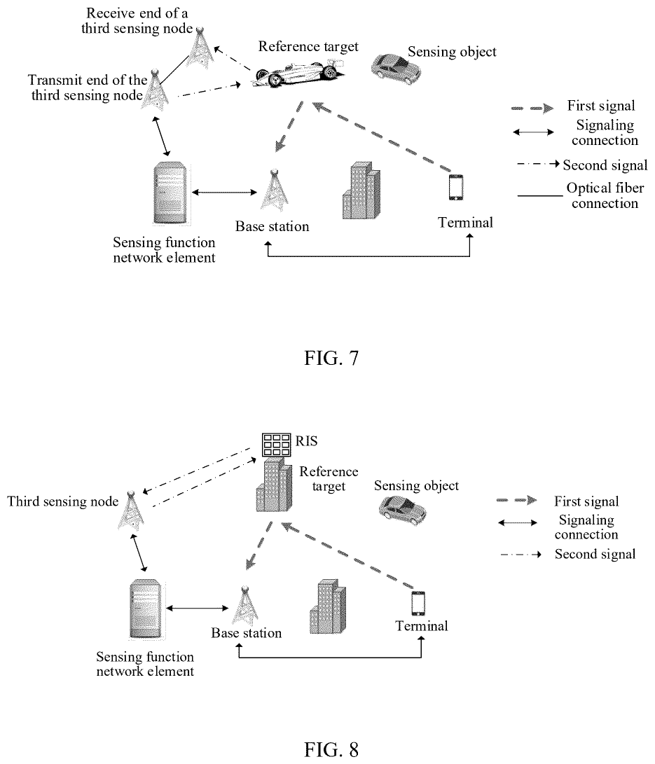

Based on at least one of the obtained timing error, frequency offset, and phase deviation between antenna ports, the sensing function network element performs correction on the obtained sensing result in the process of sensing the sensing object by the terminal and the base station.
Scenario 2: For uplink sensing shown in FIG. 7, the first device is a sensing function network element, the transmit end of the first signal (such as the first sensing node) is a terminal, the receive end of the first signal (such as the second sensing node) is a base station, and the reference target is a moving vehicle. The third sensing node includes two devices, and the two devices are the transmit end and the receive end of the second signal. The third sensing node satisfies at least one of the following requirements: the timing error and/or the frequency offset between the two devices have been calibrated; and the phase deviation between antenna ports of the receive end has been calibrated.

The processing procedure in this scenario is similar to that in Scenario 1, and details are not described here.

A difference from Scenario 1 lies in that in this scenario, the third sensing node performs sensing on the reference target in a manner of transmitting by one device and receiving by another device, the transmit end and the receive end in the third sensing node are synchronized through optical fiber connection, or the phase deviation between antenna ports of the receive end device of the third sensing node has been calibrated, so that the second sensing result is not affected by at least one of the timing error, the frequency offset, and the phase deviation between antenna ports, and the second sensing result can be used as a reference sensing result for the reference target.
Scenario 3: For uplink sensing shown in FIG. 8, the first device is a sensing function network element, the transmit end of the first signal (such as the first sensing node) is a terminal, the receive end of the first signal (such as the second sensing node) is a base station, the third sensing node is a device with a spontaneous transmission and reception capability, and the reference target is equipped with RIS.

The processing procedure in this scenario is similar to that in Scenario 1, and details are not described here.

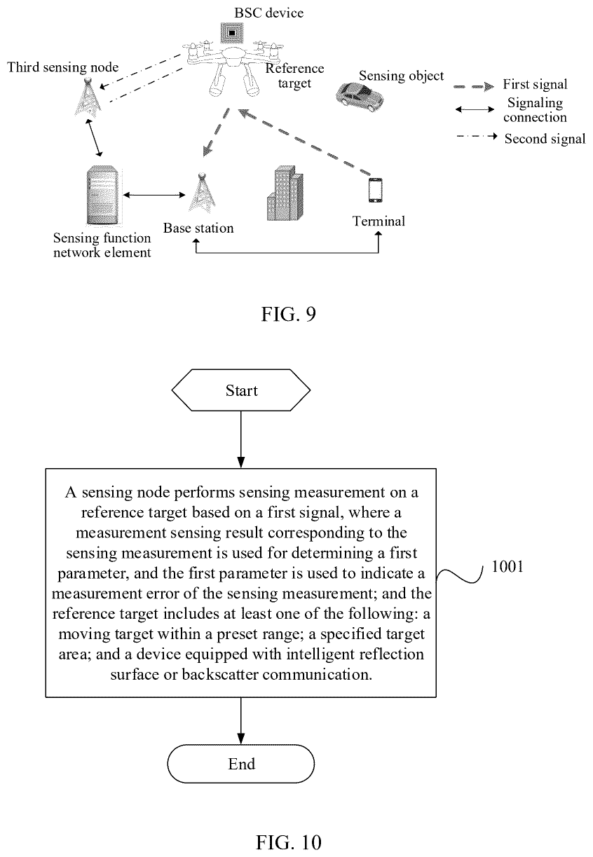

A difference from scenario 1 is that the reference target in this scenario is equipped with RIS, for example, the reference target is a building and the building is equipped with RIS. On the sensing link between the base station and the terminal, sensing is performed on the reference target to obtain a third sensing result, and the third sensing node performs sensing on the reference target to obtain a fourth sensing result. The first sensing result and the second sensing result are extracted from the third sensing result and the fourth sensing result based on RIS modulation information (for example, a RIS ID). Based on the first sensing result and the second sensing result, calibration on at least one of the timing error between the base station and the terminal, the frequency offset between the base station and the terminal, and the phase deviation between antenna ports of the base station is implemented.
Scenario 4: For uplink sensing shown in FIG. 9, the first device is a sensing function network element, the transmit end of the first signal (such as the first sensing node) is a terminal, the receive end of the first signal (such as the second sensing node) is a base station, the third sensing node is a device with a spontaneous transmission and reception capability, and the reference target is equipped with a BSC device.

The processing procedure in this scenario is similar to that in Scenario 1, and details are not described here.

A difference from scenario 1 is that the reference target in this scenario is equipped with a BSC device, for example, the reference target is an unmanned aerial vehicle in flight, and the unmanned aerial vehicle is equipped with a BSC device (such as a tag). On the sensing link between the base station and the terminal, sensing is performed on the reference target to obtain a third sensing result, and the third sensing node performs sensing on the reference target to obtain a fourth sensing result. The first sensing result and the second sensing result are extracted from the third sensing result and the fourth sensing result based on BSC modulation information (for example, a tag ID). Based on the first sensing result and the second sensing result, calibration on at least one of the timing error between the base station and the terminal, the frequency offset between the base station and the terminal, and the phase deviation between antenna ports of the base station is implemented.

To sum up, according to the method in this embodiment of this application, at least one of the timing error, the frequency offset, and the phase deviation between antennas at the receive end of the first signal can be estimated, so as to make corresponding compensation by using at least one of the estimated timing error, frequency offset, and phase deviation between antennas during sensing on the sensing object. This can reduce errors in the sensing measurement process of the sensing object and improve the sensing performance.

As shown in FIG. 10, an embodiment of this application provides a sensing processing method, including the following steps.

Step 1001: A sensing node performs sensing measurement on a reference target based on a first signal.

A measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

For example, the performing, by a sensing node, sensing measurement on a reference target based on a first signal includes at least one of the following:
in a case that the sensing node is a receive end of the first signal, receiving, by the sensing node, the first signal and obtaining first data based on the first signal; and
in a case that the sensing node is a transmit end of the first signal, sending, by the sensing node, the first signal.

For example, after the receiving, by the sensing node, the first signal and obtaining first data based on the first signal, the method further includes:
performing, by the sensing node, any one of the following:
sending the first data;
determining and sending a third sensing result based on the first data; and
determining and sending a first intermediate sensing result based on the first data.

For example, the method further includes:
receiving, by the sensing node, first signaling; and
sending, by the sensing node, first information to a first device based on the first signaling, where the first information is used for determining whether to estimate a measurement error of the sensing measurement.

For example, the first signaling satisfies at least one of the following:
the first signaling is signaling sent in a process of selecting a sensing node, or the first signaling is signaling sent after a target sensing node is determined; and
the first signaling is signaling dedicated to querying the first information.

For example, before the performing, by a sensing node, sensing measurement on a reference target based on a first signal, the following is further included:
receiving, by the sensing node, a first configuration of the first signal from a first device; where
the first configuration includes at least one of the following: a waveform signal, a signal format, a frequency domain configuration, a time domain configuration, a spatial domain configuration, an energy domain configuration, and a signal transceiving mode.

For example, the signal transceiving mode includes at least one of the following:
transmission and reception of unidirectional signals between a first sensing node and a second sensing node; and
transmission and reception of bidirectional signals between a first sensing node and a second sensing node.

For example, after the performing, by a sensing node, sensing measurement on a reference target based on a first signal, the following is further included:
receiving, by the sensing node, at least part of target parameters from a first device, where the target parameter is used for compensating a measurement error of the sensing node.

For example, the target parameter is determined based on N groups of first parameters, and each group of first parameters is determined based on a first sensing result and a second sensing result, where the first sensing result is a measurement sensing result obtained by performing sensing measurement once by the sensing node, and the second sensing result is a reference sensing result corresponding to the reference target, and N is a positive integer.

For example, in a case that N is equal to 1, the target parameter is the first parameter; and in a case that N is greater than 1, the target parameter satisfies any one of the following:
each parameter value in the target parameter is an average value of corresponding parameter values in the N groups of first parameters;
the target parameter is a group of first parameters with the highest received signal quality in the N groups of first parameters; and
each parameter value in the target parameter is an average value of corresponding parameter values in L groups of first parameters, where the L groups of first parameters are L groups of first parameters ranking the front in descending order of corresponding received signal quality in the N groups of first parameters, and L is an integer greater than 1.

For example, the first parameter includes at least one of the following:
a timing error between the first sensing node and the second sensing node;
a frequency offset between the first sensing node and the second sensing node; and
a phase deviation between antennas of a sensing node corresponding to a receive end of the first signal.

It should be noted that the method of this embodiment is implemented in cooperation with the foregoing sensing processing method executed by the first device, and the implementation of the embodiment of the foregoing sensing processing method executed by the first device is applicable to this method, with the same technical effects achieved.

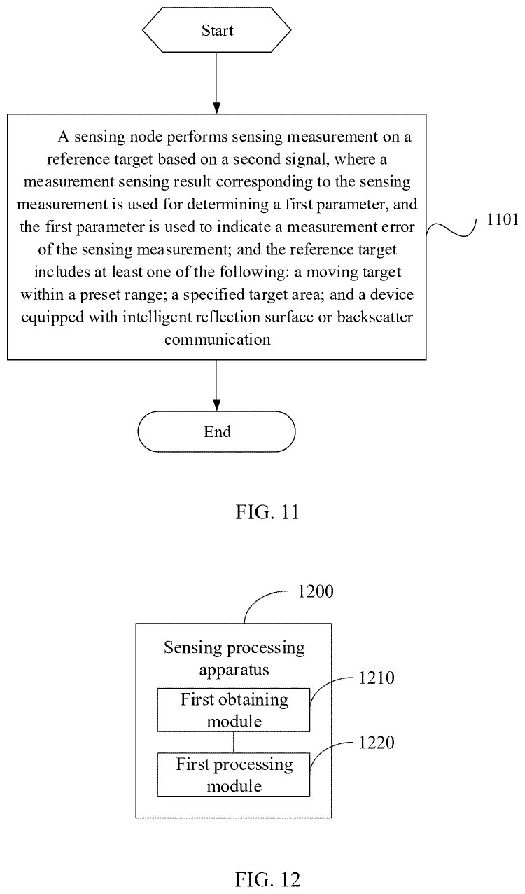

As shown in FIG. 11, an embodiment of this application provides a sensing processing method, including the following steps.

Step 1101: A sensing node performs sensing measurement on a reference target based on a second signal.

A measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

For example, the performing, by a sensing node, sensing measurement on a reference target based on a second signal includes at least one of the following:
in a case that the sensing node is a receive end of the second signal, receiving, by the sensing node, the second signal and obtaining fifth data based on the second signal; and
in a case that the sensing node is a transmit end of the second signal, sending, by the sensing node, the second signal.

For example, after the receiving, by the sensing node, the second signal and obtaining fifth data based on the second signal, the method further includes:
performing, by the sensing node, any one of the following:
sending the fifth data;
determining and sending a fourth sensing result based on the fifth data; and
determining and sending a second intermediate sensing result based on the fifth data.

For example, the method further includes:
receiving, by the sensing node, second signaling; and
sending, by the sensing node, target information to a first device based on the second signaling, where the target information includes at least one of capability information, sensing subscription information, and sensing permission information.

For example, the method further includes:
receiving, by the sensing node, third signaling, where the third signaling is used to indicate that a device receiving the third signaling is selected as a third sensing node; and
sending, by the sensing node, fourth signaling, where the fourth signaling is used to indicate whether a device sending the fourth signaling agrees to act as the third sensing node.

For example, before the performing, by a sensing node, sensing measurement on a reference target based on a second signal, the following is further included:
receiving, by the sensing node, a second configuration of the second signal from a first device; where
the second configuration includes at least one of the following: a waveform signal, a signal format, a frequency domain configuration, a time domain configuration, a spatial domain configuration, an energy domain configuration, and a signal transceiving mode.

For example, the signal transceiving mode includes at least one of the following:
spontaneous transmission and reception of signals by a sensing node;
transmission and reception of unidirectional signals between two sensing nodes; and
transmission and reception of bidirectional signals between two sensing nodes.

In the sensing processing method provided in the embodiments of this application, the execution subject may be a sensing processing apparatus. In the embodiments of this application, the sensing processing method being performed by the sensing processing apparatus is used as an example to describe the sensing processing apparatus provided in the embodiments of this application.

As shown in FIG. 12, a sensing processing apparatus according to an embodiment of this application is applied to a first device, and the sensing processing apparatus 1200 includes:
a first obtaining module 1210, configured to obtain a first sensing result and a second sensing result, where the first sensing result is a measurement sensing result obtained through sensing measurement on a reference target based on a first signal, and the second sensing result is a reference sensing result corresponding to the reference target; and
a first processing module 1220, configured to determine a first parameter based on the first sensing result and the second sensing result, where the first parameter is used to indicate a measurement error of the sensing measurement; where
the reference target includes at least one of the following:
a moving target within a preset range;
a specified target area; and
a device equipped with intelligent reflection surface or backscatter communication.

For example, the apparatus further includes:
a second obtaining module, configured to obtain first information of a target sensing node, where the target sensing node includes at least one of a first sensing node and a second sensing node; and
a first determining module, configured to determine whether to estimate a measurement error of the sensing measurement based on the first information of the target sensing node.

For example, the second obtaining module is further configured to perform any one of the following:
sending first signaling to the target sensing node and receiving the first information from the target sensing node based on the first signaling; and
obtaining the first information from a first network-side device.

For example, the first signaling satisfies at least one of the following:
the first signaling is signaling sent in a process of selecting a sensing node, or the first signaling is signaling sent after the target sensing node is determined; and
the first signaling is signaling dedicated to querying the first information.

For example, the apparatus further includes:
a third obtaining module, configured to obtain second information in a case that it is determined to estimate a measurement error of the sensing measurement; where
the second information includes at least one of the following:
location information of the target sensing node;
capability information of the target sensing node;
sensing a-priori information;
location information of a candidate sensing node in a preset spatial range;
capability information of the candidate sensing node in the preset spatial range;
sensing subscription information of the candidate sensing node in the preset spatial range;
sensing permission information of the candidate sensing node in the preset spatial range; and
third information of the reference target.

For example, the third obtaining module is further configured to:
in a case that the second information includes the location information of the target sensing node and/or the candidate sensing node, perform the following operation:
if the target sensing node and/or the candidate sensing node is a device with a fixed location, obtaining location information by accessing a first network function or receiving a report from the target sensing node and/or the candidate sensing node; where the first network function stores device location information; or
if the target sensing node and/or the candidate sensing node is a mobile device, obtaining location information by accessing a second network function; where the second network function is a positioning related network function.

For example, the third obtaining module is further configured to:
in a case that the second information includes target information and the target information is at least one of the capability information of the target sensing node and/or the candidate sensing node, the sensing subscription information, and the sensing permission information, perform any one of the following operations:
sending, by the first device, second signaling to the target sensing node and/or the candidate sensing node, and receiving the target information from the target sensing node and/or the candidate sensing node based on the second signaling; and
obtaining, by the first device, the target information from a second network-side device, where the second network-side device stores the target information.

For example, the third obtaining module is further configured to:
in a case that the second information includes the sensing a-priori information and/or third information of the reference target, obtain the sensing a-priori information and/or the third information of the reference target from an initiating node of a sensing service or a network node related to the initiating node.

For example, the sensing a-priori information includes at least one of the following:
spatial range information of a sensing target area;
a-priori information of a spatial location of a sensing object; and
motion parameter a-priori information of the sensing object.

For example, the third information of the reference target includes at least one of the following:
spatial position range information of the reference target;
spatial range information of a reference target area;
motion parameter information of the reference target; and
modulation information of the reference target.

For example, the apparatus further includes:
a second determining module, configured to determine a third sensing node based on the second information;
a first sending module, configured to send third signaling to the third sensing node, where the third signaling is used to indicate that a device receiving the third signaling is selected as the third sensing node; and
a first receiving module, configured to receive fourth signaling returned by the third sensing node, where the fourth signaling is used to indicate whether a device sending the fourth signaling agrees to act as the third sensing node.

For example, the apparatus further includes:
a third determining module, configured to determine a first configuration of a first signal and a second configuration of a second signal; where
the second signal is used for performing sensing measurement on the reference target by the third sensing node.

For example, the first configuration is determined based on fourth information, and the fourth information includes at least one of the following:
location information of the target sensing node;
capability information of the target sensing node;
sensing a-priori information; and
third information of the reference target.

For example, the second configuration is determined based on fifth information, and the fifth information includes at least one of the following:
location information of the third sensing node;
capability information of the third sensing node;
sensing a-priori information; and
third information of the reference target.

For example, the first configuration or the second configuration includes at least one of the following: signal waveform, signal format, frequency domain configuration, time domain configuration, spatial domain configuration, energy domain configuration, and signal transceiving mode.

For example, the signal transceiving mode includes at least one of the following:
spontaneous transmission and reception of signals by a sensing node;
transmission and reception of unidirectional signals between two sensing nodes; and
transmission and reception of bidirectional signals between two sensing nodes.

For example, the apparatus further includes:
a second sending module, configured to send the second configuration to the third sensing node.

For example, the apparatus further includes:
a third sending module, configured to send the first configuration to the first sensing node and/or the second sensing node.

For example, the apparatus further includes:
a fourth processing module, configured to perform sensing measurement on the reference target based on the first signal according to the first configuration to obtain a third sensing result.

For example, the fourth processing module is further configured to:
in a case that the first device is a receive end of the first signal in the target sensing node, receive the first signal to obtain first data, and determine the third sensing result based on the first data;
in a case that the first device is a transmit end of the first signal in the target sensing node, send the first signal, and receive, from a sensing node corresponding to the receive end of the first signal or a sensing function network element, a corresponding third sensing result obtained based on the sensing measurement; and
in a case that the first device is the sensing function network element, receive second data from a sensing node corresponding to the receive end of the first signal, and determine the third sensing result based on the second data.

For example, in a case that the first device is a receive end of the first signal in the target sensing node, the fourth processing module is further configured to any one of the following operations:
perform a first operation on the first data to obtain the third sensing result; and
send third data to a sensing function network element, and receive, from the sensing function network element, a third sensing result determined based on the third data, where the third data includes the first data or a first intermediate sensing result obtained by performing a second operation based on the first data, and the third sensing result is determined by the sensing function network element by performing a first operation on the first data or performing a third operation based on the first intermediate sensing result, the second operation is part of the first operation, and the third operation is an operation other than the second operation in the first operation.

For example, in a case that the first device is a sensing function network element, the fourth processing module is further configured to any one of the following operations:
in a case that the second data includes first data corresponding to the sensing measurement, performing a first operation on the first data to obtain the third sensing result;
in a case that the second data includes a first intermediate sensing result obtained by performing a second operation based on the first data, performing a third operation on the first intermediate sensing result to obtain the third sensing result; where the second operation is part of the first operation, and the third operation is an operation other than the second operation in the first operation; and
in a case that the second data includes the third sensing result, obtaining the third sensing result through receiving.

For example, the apparatus further includes:
a fifth processing module, configured to perform sensing measurement on the reference target based on the second signal according to the second configuration to obtain a fourth sensing result.

For example, the fifth processing module is further configured to:
in a case that the first device is the first sensing node or the second sensing node, receive a fourth sensing result corresponding to the sensing measurement from a sensing function network element; and
in a case that the first device is a sensing function network element, receive fourth data from a sensing node corresponding to the receive end of the second signal, and determine the fourth sensing result based on the fourth data.

For example, in a case that the first device is a sensing function network element, the fifth processing module is further configured to:
when the fourth data includes fifth data corresponding to the sensing measurement, perform, for the first device, a fourth operation on the fifth data to obtain the third sensing result; and
when the fourth data includes a second intermediate sensing result obtained by performing a fifth operation on the fifth data, perform, for the first device, a sixth operation on the second intermediate sensing result to obtain a fourth sensing result; where the fifth operation is part of the fourth operation, and the sixth operation is an operation other than the fifth operation in the fourth operation.

For example, the third sensing result or the fourth sensing result includes at least one of: distance; Doppler; angle; one-dimensional spectrum of range; one-dimensional spectrum of Doppler; one-dimensional spectrum of angle; two-dimensional spectrum of distance and Doppler; two-dimensional spectrum of azimuth angle and pitch angle; two-dimensional spectrum of distance and angle; three-dimensional spectrum of distance, azimuth angle, and pitch angle; three-dimensional spectrum of distance, Doppler, and angle; and four-dimensional spectrum of range, Doppler, azimuth angle, and pitch angle.

For example, the first obtaining module is further configured to:
determine the first sensing result and/or the second sensing result based on the third sensing result and/or the fourth sensing result.

For example, the first obtaining module is further configured to:
determine the first sensing result based on the third sensing result, and determine the second sensing result based on the fourth sensing result; or
determine the first sensing result and the second sensing result based on the third sensing result and the fourth sensing result.

For example, the first obtaining module is further configured to perform at least one of the following:
separately determining the first sensing result and the second sensing result based on patterns with associated characteristics in the third sensing result and the fourth sensing result;
performing matching on the third sensing result and the fourth sensing result, and separately determining the first sensing result and the second sensing result based on successfully matched patterns in the third sensing result and the fourth sensing result; and
extracting the first sensing result and the second sensing result from the third sensing result and the fourth sensing result based on modulation information of the reference target.

For example, the first sensing result includes at least one of the following: delay, Doppler, and angle.

The second sensing result includes at least one of the following: delay, Doppler, and angle.

For example, the first parameter includes at least one of the following:
a timing error between the first sensing node and the second sensing node;
a frequency offset between the first sensing node and the second sensing node; and
a phase deviation between antennas of a sensing node corresponding to a receive end of the first signal; where
the first sensing node and the second sensing node are used for performing sensing measurement on a reference target based on the first signal.

For example, in a case that a signal transceiving mode of the first signal is transmission and reception of unidirectional signals between a first sensing node and a second sensing node, the first processing module is further configured to perform at least one of the following:
determining a timing error in the first parameter based on a delay in the first sensing result and a delay in the second sensing result;
determining a frequency offset in the first parameter based on a Doppler in the first sensing result and a Doppler in the second sensing result; and
determining a phase deviation between antennas of a fourth sensing node in the first parameter based on a first measured phase between the antennas of the fourth sensing node and a first reference phase between the antennas of the fourth sensing node, where the first measurement phase is determined through derivation based on an angle in the first sensing result, the first reference phase is determined through derivation based on an angle in the second sensing result, the fourth sensing node is the first sensing node or the second sensing node, and the fourth sensing node is a sensing node corresponding to a receive end of the first signal.

For example, in a case that a signal transceiving mode of the first signal is transmission and reception of bidirectional signals between a first sensing node and a second sensing node, the first processing module is further configured to perform at least one of the following:
determining a timing error in the first parameter based on a first delay, a second delay, and a delay in the second sensing result; where the first delay is a delay in the first sensing result that is obtained based on the second sensing node acting as a receive end of the first signal, and the second delay is a delay in the first sensing result that is obtained based on the second sensing node acting as a transmit end of the first signal;
determining a frequency offset in the first parameter based on a first Doppler, a second Doppler, and a Doppler in the second sensing result; where the first Doppler is a Doppler in the first sensing result that is obtained based on the second sensing node acting as a receive end of the first signal, and the second Doppler is a Doppler in the first sensing result that is obtained based on the second sensing node acting as a transmit end of the first signal; and
determining a phase deviation between antennas of a fourth sensing node in the first parameter based on a first measured phase between the antennas of the fourth sensing node and a first reference phase between the antennas of the fourth sensing node, where the first measurement phase is determined through derivation based on an angle in the first sensing result, the first reference phase is determined based on an angle in the second sensing result, the fourth sensing node is the first sensing node or the second sensing node, and the fourth sensing node is a sensing node corresponding to a receive end of the first signal.

For example, the apparatus further includes:
a fourth determining module, configured to determine a target parameter based on the first parameter, where the target parameter is used for compensating a measurement error of the sensing node; and
send, for the first device, at least part of the target parameters to a target device, where the target device includes at least one of a first sensing node, a second sensing node, and a sensing function network element.

For example, the target parameter is determined based on N groups of first parameters determined by the first device, where N is a positive integer.

In a case that N is equal to 1, the target parameter is the first parameter; and in a case that N is greater than 1, the target parameter satisfies any one of the following:
each parameter value in the target parameter is an average value of corresponding parameter values in the N groups of first parameters;
the target parameter is a group of first parameters with the highest received signal quality in the N groups of first parameters; and
each parameter value in the target parameter is an average value of corresponding parameter values in L groups of first parameters, where the L groups of first parameters are L groups of first parameters ranking the front in descending order of corresponding received signal quality in the N groups of first parameters, and Lis an integer greater than 1.

The apparatus in this embodiment of this application may be a base station or a sensing function network element, which is not specifically limited in the embodiments of this application.

The sensing processing apparatus provided in this embodiment of this application is capable of implementing the processes implemented in the method embodiments in FIG. 2 to FIG. 9, with the same technical effects achieved. To avoid repetition, details are not described herein again.

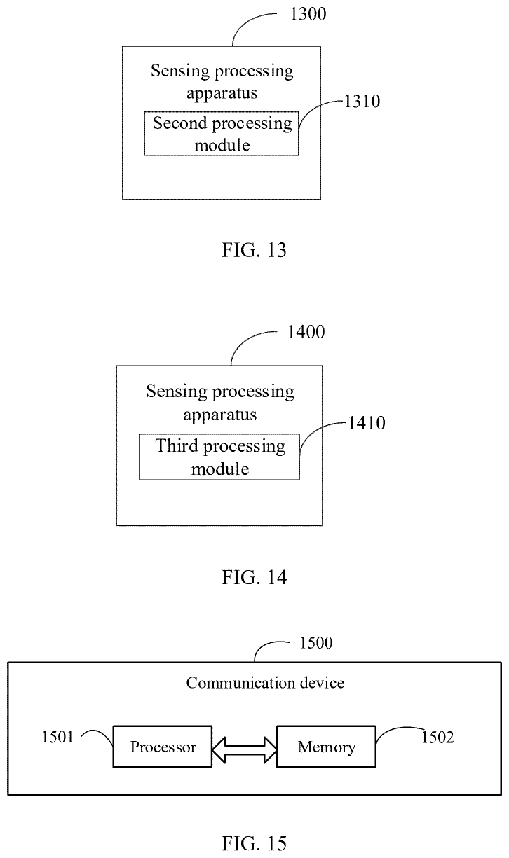

As shown in FIG. 13, an embodiment of this application provides a sensing processing apparatus, applied to a sensing node, and the sensing processing apparatus 1300 includes:
a second processing module 1310, configured to perform sensing measurement on a reference target based on a first signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

In this embodiment, the sensing node may be the first sensing node and/or the second sensing node in the foregoing embodiments.

For example, the second processing module is further configured to perform at least one of the following:
in a case that the sensing node is a receive end of the first signal, receive the first signal and obtain first data based on the first signal; and
in a case that the sensing node is a transmit end of the first signal, send the first signal.

For example, the apparatus further includes:
a sixth processing module, configured to perform any one of the following:
sending the first data;
determining and sending a third sensing result based on the first data; and
determining and sending a first intermediate sensing result based on the first data.

For example, the apparatus further includes:
a second receiving module, configured to receive first signaling; and
a fourth sending module, configured to send first information to a first device based on the first signaling, where the first information is used for determining whether to estimate a measurement error of the sensing measurement.

For example, the first signaling satisfies at least one of the following:
the first signaling is signaling sent in a process of selecting a sensing node, or the first signaling is signaling sent after a target sensing node is determined; and
the first signaling is signaling dedicated to querying the first information.

For example, the apparatus further includes:
a third receiving module, configured to receive a first configuration of the first signal from a first device; where
the first configuration includes at least one of the following: a waveform signal, a signal format, a frequency domain configuration, a time domain configuration, a spatial domain configuration, an energy domain configuration, and a signal transceiving mode.

For example, the signal transceiving mode includes at least one of the following:
transmission and reception of unidirectional signals between a first sensing node and a second sensing node; and
transmission and reception of bidirectional signals between a first sensing node and a second sensing node.

For example, after the performing, by a sensing node, sensing measurement on a reference target based on a first signal, the following is further included:
a fourth receiving module, configured to receive at least part of target parameters from a first device, where the target parameter is used for compensating a measurement error of the sensing node.

For example, the target parameter is determined based on N groups of first parameters, and each group of first parameters is determined based on a first sensing result and a second sensing result, where the first sensing result is a measurement sensing result obtained by performing sensing measurement once by the sensing node, and the second sensing result is a reference sensing result corresponding to the reference target, and N is a positive integer.

For example, in a case that N is equal to 1, the target parameter is the first parameter; and in a case that N is greater than 1, the target parameter satisfies any one of the following:
each parameter value in the target parameter is an average value of corresponding parameter values in the N groups of first parameters;
the target parameter is a group of first parameters with the highest received signal quality in the N groups of first parameters; and
each parameter value in the target parameter is an average value of corresponding parameter values in L groups of first parameters, where the L groups of first parameters are L groups of first parameters ranking the front in descending order of corresponding received signal quality in the N groups of first parameters, and L is an integer greater than 1.

For example, the first parameter includes at least one of the following:
a timing error between the first sensing node and the second sensing node;
a frequency offset between the first sensing node and the second sensing node; and
a phase deviation between antennas of a sensing node corresponding to a receive end of the first signal.

The apparatus in this embodiment of this application may be a terminal or a network-side device, which is not specifically limited in the embodiments of this application.

The sensing processing apparatus provided in this embodiment of this application is capable of implementing the processes implemented in the method embodiments in FIG. 10, with the same technical effects achieved. To avoid repetition, details are not described herein again.

As shown in FIG. 14, an embodiment of this application provides a sensing processing apparatus, applied to a sensing node, and the sensing processing apparatus 1400 includes:
a third processing module 1410, configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

In this embodiment, the sensing node may be the third sensing node in the foregoing embodiments.

For example, the third processing module is further configured to perform at least one of the following:
in a case that the sensing node is a receive end of the second signal, receiving the second signal and obtaining fifth data based on the second signal; and
in a case that the sensing node is a transmit end of the first signal, sending the first signal.

For example, the apparatus further includes:
a seventh processing module, configured to perform any one of the following:
sending the fifth data;
determining and sending a fourth sensing result based on the fifth data; and
determining and sending a second intermediate sensing result based on the fifth data.

For example, the apparatus further includes:
a fifth receiving module, configured to receive second signaling; and
a fifth sending module, configured to send target information to a first device based on the second signaling, where the target information includes at least one of capability information, sensing subscription information, and sensing permission information.

For example, the method further includes:
a sixth receiving module, configured to receive third signaling, where the third signaling is used to indicate that a device receiving the third signaling is selected as a third sensing node; and
a sixth sending module, configured to send fourth signaling, where the fourth signaling is used to indicate whether a device sending the fourth signaling agrees to act as the third sensing node.

For example, the apparatus further includes:
a seventh receiving module, configured to receive a second configuration of the second signal from a first device; where
the second configuration includes at least one of the following: a waveform signal, a signal format, a frequency domain configuration, a time domain configuration, a spatial domain configuration, an energy domain configuration, and a signal transceiving mode.

For example, the signal transceiving mode includes at least one of the following:
spontaneous transmission and reception of signals by a sensing node;
transmission and reception of unidirectional signals between two sensing nodes; and
transmission and reception of bidirectional signals between two sensing nodes.

The apparatus in this embodiment of this application may be a terminal or a network-side device, which is not specifically limited in the embodiments of this application.

The sensing processing apparatus provided in this embodiment of this application is capable of implementing the processes implemented in the method embodiments in FIG. 11, with the same technical effects achieved. To avoid repetition, details are not described herein again.

For example, as shown in FIG. 15, an embodiment of this application further provides a communication device 1500, including a processor 1501 and a memory 1502. A program or instructions capable of running on the processor 1501 are stored in the memory 1502. When the program or the instructions are executed by the processor 1501, the steps of the foregoing sensing processing method embodiments are implemented, with the same technical effects achieved. To avoid repetition, details are not described herein again.

An embodiment of this application further provides a terminal, including a processor and a communication interface.

In a case that the terminal is a first sensing node or a second sensing node, the processor is configured to perform sensing measurement on a reference target based on a first signal; or

In a case that the terminal is a third sensing node, the processor is configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

The terminal embodiments correspond to the foregoing terminal-side method embodiments, and the implementation processes and implementations of the foregoing method embodiments can be applied to the terminal embodiments, with the same technical effects achieved.

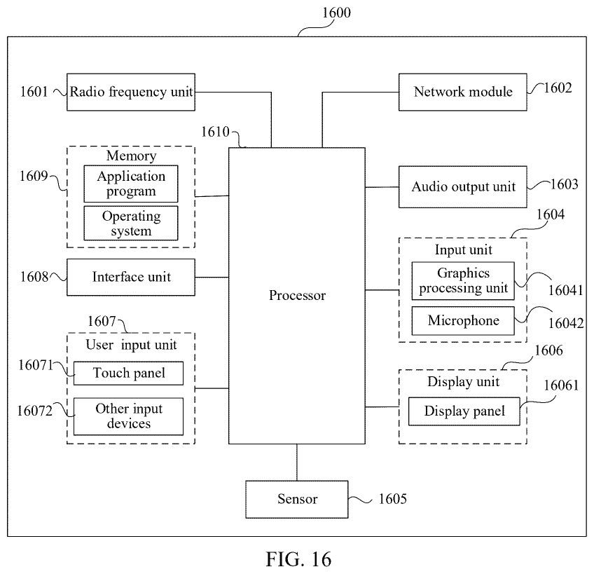

In some embodiments, FIG. 16 is a schematic diagram of a hardware structure of a terminal for implementing the embodiments of this application.

The terminal 1600 includes but is not limited to at least part of components such as a radio frequency unit 1601, a network module 1602, an audio output unit 1603, an input unit 1604, a sensor 1605, a display unit 1606, a user input unit 1607, an interface unit 1608, a memory 1609, and a processor 1610.

Persons skilled in the art can understand that the terminal 1600 may further include a power supply (for example, a battery) supplying power to the components, and the power supply may be logically connected to the processor 1610 through a power management system. In this way, functions such as charge management, discharge management, and power consumption management are implemented by using the power management system. The structure of the terminal shown in FIG. 16 does not constitute any limitation on the terminal. The terminal may include more or fewer components than those shown in the figure, or a combination of some components, or the components disposed differently. Details are not described herein again.

It can be understood that in this embodiment of this application, the input unit 1604 may include a Graphics Processing Unit (GPU) 16041 and a microphone 16042. The graphics processing unit 16041 processes image data of a still picture or video obtained by an image capture apparatus (such as a camera) in a video capture mode or an image capture mode. The display unit 1606 may include a display panel 16061, and the display panel 16061 may be configured in a form of a liquid crystal display, an organic light-emitting diode, and the like. The user input unit 1607 may include at least one of a touch panel 16071 and other input devices 16072. The touch panel 16071 is also referred to as a touchscreen. The touch panel 16071 may include two parts: a touch detection apparatus and a touch controller. The other input devices 16072 may include but are not limited to a physical keyboard, a function key (such as a volume control key or a power on/off key), a trackball, a mouse, a joystick, and the like. Details are not described herein.

In this embodiment of this application, the radio frequency unit 1601 receives downlink data from a network-side device, and then sends the downlink data to the processor 1610 for processing. In addition, the radio frequency unit 1601 may send uplink data to the network-side device. Generally, the radio frequency unit 1601 includes but is not limited to an antenna, an amplifier, a transceiver, a coupler, a low noise amplifier, a duplexer, and the like.

The memory 1609 may be configured to store software programs or instructions and various data. The memory 1609 may include a first storage area for storing a program or instructions and a second storage area for storing data. The first storage area may store an operating system, an application program or instruction required by at least one function (for example, a sound playback function or an image playback function), and the like. In addition, the memory 1609 may include a volatile memory or a non-volatile memory, or the memory 1609 may include both a volatile memory and a non-volatile memory. The non-volatile memory may be a Read-Only Memory (ROM), a Programmable ROM (PROM), an Erasable PROM (EPROM), and an Electrically EPROM (EEPROM), or flash memory. The volatile memory can be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1609 in the embodiments of this application includes but is not limited to these and any other suitable types of memories.

The processor 1610 may include one or more processing units. For example, an application processor and a modem processor may be integrated in the processor 1610. This application processor primarily processes operations involving an operating system, user interfaces, application programs, and the like. The modem processor primarily processes radio communication signals, for example, being a baseband processor. It can be understood that, in some embodiments, the modem processor may be not integrated in the processor 1610.

In a case that the terminal is a first sensing node or a second sensing node, the processor 1610 is configured to perform sensing measurement on a reference target based on a first signal; or
in a case that the terminal is a third sensing node, the processor 1610 is configured to perform sensing measurement on a reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

In this embodiment of this application, the terminal may be used as the first device to execute the sensing processing method executed by the first device as described above, which is not repeated herein.

An embodiment of this application further provides a network-side device, including a processor and a communication interface.

In a case that the network-side device is a first device, the processor is configured to obtain a first sensing result and a second sensing result, where the first sensing result is a measurement sensing result obtained through sensing measurement on a reference target based on a first signal, and the second sensing result is a reference sensing result corresponding to the reference target; and determine a first parameter based on the first sensing result and the second sensing result, where the first parameter is used to indicate a measurement error of the sensing measurement; or
in a case that the network-side device is a sensing node, and the sensing node is a first sensing node or a second sensing node, the processor is configured to perform sensing measurement on a reference target based on a first signal; or, in a case that the sensing node is a third sensing node, the processor is configured to perform sensing measurement on the reference target based on a second signal; where
a measurement sensing result corresponding to the sensing measurement is used for determining a first parameter, and the first parameter is used to indicate a measurement error of the sensing measurement; and
the reference target includes at least one of the following:
a moving target within a preset range;
a specified target area; and
a device equipped with intelligent reflection surface or backscatter communication.

The network-side device embodiments correspond to the foregoing network-side device method embodiments, and the implementation processes and implementations of the foregoing method embodiments can be applied to the network-side device embodiments, with the same technical effects achieved.

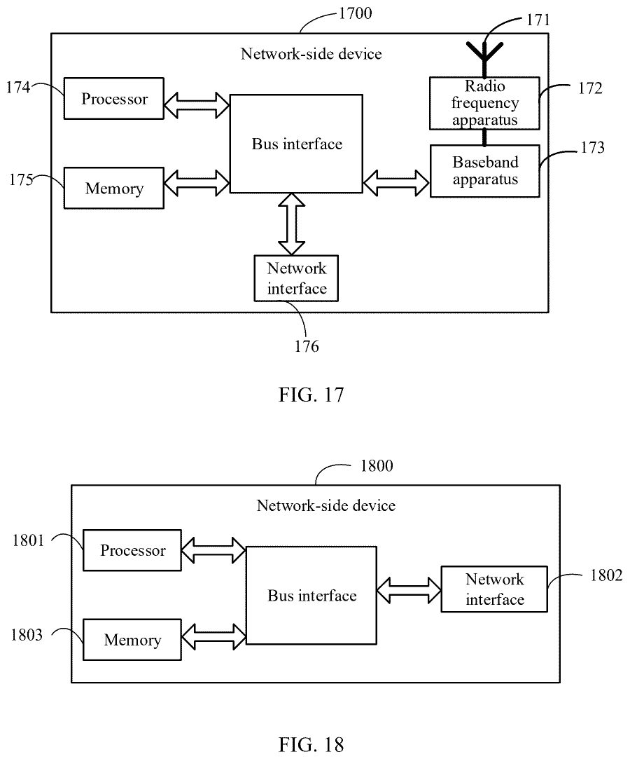

For example, an embodiment of this application further provides a network-side device. As shown in FIG. 17, the network-side device 1700 includes an antenna 171, a radio frequency apparatus 172, a baseband apparatus 173, a processor 174, and a memory 175. The antenna 171 is connected to the radio frequency apparatus 172. In an uplink direction, the radio frequency apparatus 172 receives information by using the antenna 171, and sends the received information to the baseband apparatus 173 for processing. In a downlink direction, the baseband apparatus 173 processes to-be-sent information, and sends the information to the radio frequency apparatus 172; and the radio frequency apparatus 172 processes the received information and then sends the information out by using the antenna 171.

The method executed by the network-side device in the foregoing embodiments can be implemented in the baseband apparatus 173, and the baseband apparatus 173 includes a baseband processor.

The baseband apparatus 173 may include, for example, at least one baseband board, where a plurality of chips are disposed on the baseband board. As shown in FIG. 17, one of the chips is, for example, a baseband processor, and is connected to the memory 175 through the bus interface, to invoke a program in the memory 175 to perform the operations of the network device shown in the foregoing method embodiments.

The network-side device may further include a network interface 176, where the interface is, for example, a Common Public Radio Interface (CPRI).

In some embodiments, the network-side device 1700 in this embodiment of this application further includes: instructions or a program stored in the memory 175 and capable of running on the processor 174. The processor 174 invokes the instructions or program in the memory 175 to execute the method executed by the modules shown in FIG. 12, FIG. 13, or FIG. 14, with the same technical effects achieved. To avoid repetition, details are not repeated herein.

For example, an embodiment of this application further provides a network-side device. As shown in FIG. 18, the network-side device 1800 includes a processor 1801, a network interface 1802, and a memory 1803. The network interface 1802 is, for example, a CPRI.

In some embodiments, the network-side device 1800 in this embodiment of this application further includes: instructions or a program stored in the memory 1803 and capable of running on the processor 1801. The processor 1801 invokes the instructions or program in the memory 1803 to execute the method executed by the modules shown in FIG. 12, FIG. 13, or FIG. 14, with the same technical effects achieved. To avoid repetition, details are not repeated herein.

An embodiment of this application further provides a server, where the server includes a processor and a communication interface. The communication interface is coupled to the processor, and the processor is configured to run a program or instructions to implement the processes of the foregoing embodiments of the sensing processing method, with the same technical effects achieved. To avoid repetition, details are not described herein again.

An embodiment of this application further provides a readable storage medium, where a program or an instruction is stored in the readable storage medium. When the program or the instruction is executed by a processor, the processes of the foregoing embodiment of the sensing processing method can be implemented, with the same technical effects achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or instructions to implement the processes of the foregoing sensing processing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing sensing processing method embodiments, with the same technical effects achieved. To avoid repetition, details are not repeated herein.

An embodiment of this application further provides a sensing processing system, including a terminal and a network-side device, where the terminal can be configured to execute the processes of the foregoing embodiments of the sensing processing method executed by the sensing node, and the network-side device can be configured to execute the processes of foregoing embodiments of the sensing processing method executed by the first device or sensing node.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to executing the functions in an order shown or discussed, but may also include executing the functions in a substantially simultaneous manner or in a reverse order, depending on the functions involved. For example, the described methods may be performed in an order different from that described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. The method in the foregoing embodiments may be implemented by hardware. However, in many cases, the former is an example implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A sensing processing method, comprising:
obtaining, by a first device, a first sensing result and a second sensing result, wherein the first sensing result is a measurement sensing result obtained through sensing measurement on a reference target based on a first signal, and the second sensing result is a reference sensing result corresponding to the reference target; and
determining, by the first device, a first parameter based on the first sensing result and the second sensing result, wherein the first parameter is used to indicate a measurement error of the sensing measurement, wherein
the reference target comprises at least one of the following:
a moving target within a preset range;
a specified target area; or
a device equipped with intelligent reflection surface or backscatter communication.

2. The method according to claim 1, wherein before the obtaining, by the first device, the first sensing result and a second sensing result, the method further comprises:
obtaining, by the first device, first information of a target sensing node, wherein the target sensing node comprises at least one of a first sensing node or a second sensing node; and
determining, by the first device, whether to estimate a measurement error of the sensing measurement based on the first information of the target sensing node.

3. The method according to claim 2, wherein the obtaining, by the first device, the first information of the target sensing node comprises any one of the following:
sending, by the first device, first signaling to the target sensing node and receiving the first information from the target sensing node based on the first signaling; or
obtaining, by the first device, the first information from a first network-side device.

4. The method according to claim 3, wherein the first signaling satisfies at least one of the following:
the first signaling is signaling sent in a process of selecting a sensing node, or the first signaling is signaling sent after the target sensing node is determined; or
the first signaling is signaling dedicated to querying the first information.

5. The method according to claim 2, further comprising:
obtaining, by the first device, second information when it is determined to estimate the measurement error of the sensing measurement, wherein
the second information comprises at least one of the following:
location information of the target sensing node;
capability information of the target sensing node;
sensing a-priori information;
location information of a candidate sensing node in a preset spatial range;
capability information of the candidate sensing node in the preset spatial range;
sensing subscription information of the candidate sensing node in the preset spatial range;
sensing permission information of the candidate sensing node in the preset spatial range;
or
third information of the reference target.

6. The method according to claim 5, wherein the obtaining, by the first device, second information comprises:
when the second information comprises the location information of the target sensing node or the candidate sensing node, performing, by the first device, the following operation:
when the target sensing node or the candidate sensing node is a device with a fixed location, obtaining location information by accessing a first network function or receiving a report from the target sensing node or the candidate sensing node; wherein the first network function stores device location information; or
when the target sensing node or the candidate sensing node is a mobile device, obtaining location information by accessing a second network function; wherein the second network function is a positioning related network function,
when the second information comprises target information and the target information is at least one of the capability information of the target sensing node or the candidate sensing node, the sensing subscription information, or the sensing permission information, performing, by the first device, any one of the following operations:
sending, by the first device, second signaling to the target sensing node or the candidate sensing node, and receiving the target information from the target sensing node or the candidate sensing node based on the second signaling; or
obtaining, by the first device, the target information from a second network-side device, wherein the second network-side device stores the target information,
when the second information comprises the sensing a-priori information or third information of the reference target, obtaining, by the first device, the sensing a-priori information or the third information of the reference target from an initiating node of a sensing service or a network node related to the initiating node.

7. The method according to claim 5, wherein the sensing a-priori information comprises at least one of the following:
spatial range information of a sensing target area;
a-priori information of a spatial location of a sensing object; or
motion parameter a-priori information of the sensing object, or
wherein the third information of the reference target comprises at least one of the following:
spatial position range information of the reference target;
spatial range information of a reference target area;
motion parameter information of the reference target; or
modulation information of the reference target.

8. The method according to claim 5, wherein after the obtaining, by the first device, the second information, the method further comprises:
determining, by the first device, a third sensing node based on the second information;
sending, by the first device, third signaling to the third sensing node, wherein the third signaling is used to indicate that a device receiving the third signaling is selected as the third sensing node; and
receiving, by the first device, fourth signaling returned by the third sensing node, wherein the fourth signaling is used to indicate whether a device sending the fourth signaling agrees to act as the third sensing node.

9. The method according to claim 8, wherein before the obtaining, by the first device, the first sensing result and the second sensing result, the method further comprises:
determining, by the first device, a first configuration of a first signal and a second configuration of a second signal; wherein
the second signal is used for performing sensing measurement on the reference target by the third sensing node.

10. The method according to claim 9, wherein the first configuration is determined based on fourth information, and the fourth information comprises at least one of the following:
location information of the target sensing node;
capability information of the target sensing node;
sensing a-priori information; or
third information of the reference target, or
wherein the second configuration is determined based on fifth information, and the fifth information comprises at least one of:
location information of the third sensing node;
capability information of the third sensing node;
sensing a-priori information; or
third information of the reference target, or
wherein the first configuration or the second configuration comprises at least one of the following: signal waveform, signal format, frequency domain configuration, time domain configuration, spatial domain configuration, energy domain configuration, or signal transceiving mode.

11. The method according to claim 9, after the determining, by the first device, the second configuration of the second signal, the method further comprises:
sending, by the first device, the second configuration to the third sensing node.

12. The method according to claim 9, after the determining, by the first device, the first configuration of the first signal, the method further comprises:
sending, by the first device, the first configuration to the first sensing node or the second sensing node, or
performing, by the first device, sensing measurement on the reference target based on the first signal according to the first configuration to obtain a third sensing result.

13. A sensing processing method, comprising:
performing, by a sensing node, sensing measurement on a reference target based on a first signal; wherein
a measurement sensing result corresponding to the sensing measurement is used for determining a first parameter, and the first parameter is used to indicate a measurement error of the sensing measurement; and
the reference target comprises at least one of the following:
a moving target within a preset range;
a specified target area; or
a device equipped with intelligent reflection surface or backscatter communication.

14. The method according to claim 13, wherein the performing, by the sensing node, the sensing measurement on the reference target based on the first signal comprises at least one of the following:
when the sensing node is a receive end of the first signal, receiving, by the sensing node, the first signal and obtaining first data based on the first signal; or
when the sensing node is a transmit end of the first signal, sending, by the sensing node, the first signal.

15. The method according to claim 14, wherein after the receiving, by the sensing node, the first signal and obtaining the first data based on the first signal, the method further comprises:
performing, by the sensing node, any one of the following:
sending the first data;
determining and sending a third sensing result based on the first data; or
determining and sending a first intermediate sensing result based on the first data.

16. The method according to claim 13, before the performing, by the sensing node, the sensing measurement on the reference target based on a first signal, the method further comprises:
receiving, by the sensing node, a first configuration of the first signal from a first device; wherein
the first configuration comprises at least one of the following: a waveform signal, a signal format, a frequency domain configuration, a time domain configuration, a spatial domain configuration, an energy domain configuration, or a signal transceiving mode.

17. The method according to claim 13, wherein the first parameter comprises at least one of the following:
a timing error between the first sensing node and the second sensing node;
a frequency offset between the first sensing node and the second sensing node; or
a phase deviation between antennas of a sensing node corresponding to a receive end of the first signal.

18. A sensing processing method, comprising:
performing, by a sensing node, sensing measurement on a reference target based on a second signal; wherein
a measurement sensing result corresponding to the sensing measurement is used for determining a first parameter, and the first parameter is used to indicate a measurement error of the sensing measurement; and
the reference target comprises at least one of the following:
a moving target within a preset range;
a specified target area; or
a device equipped with intelligent reflection surface or backscatter communication.

19. The method according to claim 18, wherein the performing, by the sensing node, the sensing measurement on the reference target based on the second signal comprises at least one of the following:
when the sensing node is a receive end of the second signal, receiving, by the sensing node, the second signal and obtaining fifth data based on the second signal; or
when the sensing node is a transmit end of the second signal, sending, by the sensing node, the second signal.

20. The method according to claim 18, further comprising:
receiving, by the sensing node, third signaling, wherein the third signaling is used to indicate that a device receiving the third signaling is selected as a third sensing node; and
sending, by the sensing node, fourth signaling, wherein the fourth signaling is used to indicate whether a device sending the fourth signaling agrees to act as the third sensing node.
